(19) United States
(12) Patent Application Publication
(10) Pub. No.: US 2006/0149595 A1
(43) Pub. Date: Jul. 6, 2006

(54) System and method of integrating information related to health care savings accounts and health care plans

(75) Inventors: James Williams, Huntington Beach, CA (US); Joseph Vason V, Ft. Lauderdale, FL (US); Robert M. Anderson, Newport Beach, CA (US)

Correspondence Address: CROWELL & MORING LLP;INTELLECTUAL PROPERTY GROUP, P.O. BOX 14300, WASHINGTON, DC, 20044-4300, US

(73) Assignee: AFA Technologies, Inc.

(21) Appl. No.: 11/028,122

(22) Filed: Dec. 30, 2004

(51) Int. Cl. G06Q 10/00; G06Q 50/00

(52) U.S. Cl. 705/2

(57) ABSTRACT

A system, method, and software module that integrates a subscriber's health care savings account information with the subscriber's health plan information, and provides the integrated information to the subscriber upon request, and performs a multitude of other functions. The integration software module also performs additional functions such as facilitating transactions for payment of medical claims with HSA account funds; correlating transaction information with claim information; providing a subscriber the ability to access his/her HSA account and/or other financial accounts and/or lines-of-credit to pay for health care expenses; assisting in the preparation of tax forms for the subscriber; providing the subscriber on-line shopping for medical services and products, and qualified supplemental insurance; facilitating the investment of HSA account funds into investment accounts; providing subscriber-authorized third-party temporary access to the specified subscriber information; and generating statistical analysis reports.

### FIELD OF THE INVENTION

This invention relates generally to accumulating and processing different information, and in particular, to a system and method of integrating subscriber information related to health care savings accounts and health care plans.

### BACKGROUND OF THE INVENTION

In 2003, the U.S. Congress passed the 2003 Medicare Prescription Drug Bill which establishes Health Savings Accounts (HSAs). An HSA account is an individual (or family) savings account, managed by a financial institution (e.g., a bank), which holds funds to be used for payment of a subscriber's (i.e., individual or family) qualified medical expenses on a limited tax exempt basis. Once an HSA account has been set up for a subscriber, the subscriber and/or the subscriber's employer may periodically contribute pre-tax money to the HSA account.

If the subscriber authorizes the withdrawal of funds from the HSA account for payment of a qualified medical expense, such withdrawal will not result in a taxable event for the subscriber. However, the cumulative deposits into the HSA account during the current calendar year cannot exceed a specified limit. At the moment, the specified limit for an individual HSA account is $2600, and for a family HSA account is $5150. The subscriber may also authorize withdrawals for payment of non-qualified expenses. However, such withdrawals would generally be considered taxable events for the subscriber.

Like a regular savings account, the HSA account accrues interest over time. In addition, the funds in the HSA account roll over from year-to-year. This allows a subscriber to use the HSA account as a savings tool which may be used, for example, during the retirement phase of the subscriber. Accordingly, funds from the HSA account may be used by a subscriber at retirement to supplement his/her Medicare coverage as well as pay for retirement living expenses.

An HSA account is typically associated with a health care coverage plan provided to the subscriber by a health care insurer. The health care insurer provides a health care coverage plan to the subscriber that typically has a relatively high deductible. For example, at the moment, such deductible may be as low as $1000 for an individual and $2000 for a family. Within a calendar year, a subscriber is responsible for payment of medical expenses up to the deductible. Once the deductible is met, the health care insurer is responsible for payment of medical expenses above the deductible within the calendar year. The subscriber may choose to pay medical expenses from funds from his/her HSA account and/or from other sources.

Not all payments of medical expenses made by the subscriber applies towards the deductible. For example, if the subscriber buys a non-generic drug costing $60 where the generic drug costs the health care insurer only $20, the health care insurer may only apply $20 towards the deductible. However, although only $20 applies towards the deductible, the whole medical expense (i.e., $60) may still be considered an HSA qualified medical expense, which may not trigger a taxable event if paid with funds from the HSA account. As mentioned above, the subscriber is allowed to withdraw funds from the HSA account to pay for non-qualified expenses (e.g., the subscriber buys a toy for his/her child). However, such withdrawal would be a taxable event for the subscriber.

For privacy and other purposes, generally financial institutions provide information related to HSA accounts only to the account holders, i.e. the subscribers. Such HSA account information is not typically provided to health care insurers. By the same token, generally health care insurers provide information related to health care claims only to the subscribers. Such health care claim information is not provided to financial institutions. Due to the Health Insurance Portability and Accountability Act (HIPPA) requirements, a financial institution may not desire to receive health care claim information of a subscriber.

Accordingly, subscribers receive information related to their respective HSA accounts and health care plans from two different sources, i.e., the financial institution and the health care insurer. The managing of both types of information may be difficult for many subscribers. For example, subscribers may desire to keep track of the current balance of the HSA account to ensure that there are sufficient funds to pay for accrued medical expenses. Subscribers may also desire to keep track of how much money has been paid towards the deductible. In addition, subscribers may want to keep track, for tax purposes, of which withdrawals from their HSA accounts went towards qualified and unqualified medical expenses. Subscribers may also want to keep track of other HSA account and medical claim information.

As discussed above, in the past subscribers have received both HSA account information and medical claims information from two different sources, i.e., the financial institution and the health care insurer. It is up to the subscribers to aggregate, organize, and keep track of both types of information. Such a chore is difficult for many subscribers, especially for elderly subscribers who generally require more medical attention, and accordingly, will have to aggregate, organize, and keep track of more information.

### SUMMARY OF THE INVENTION

The invention relates to a health savings account—medical plan (HSA-MP) integration software module that integrates a subscriber's HSA account information with the subscriber's health plan information, provides the integrated information to the subscriber upon request, and performs a multitude of other functions. The HSA-MP integration software module, upon a subscriber enrolling for services, creates a subscriber data object for keeping track of both subscriber HSA account information and health plan information. The HSA-MP integration software module updates the subscriber data object each time it receives new HSA account information and/or health plan information for the subscriber. Since the HSA-MP integration software module constantly updates the subscriber data object, it is able to provide current HSA account and health plan information to the subscriber upon request.

The HSA-MP integration software module also performs additional functions such as facilitating transactions for payment of medical claims with HSA account funds; correlating transaction information with claim information; providing a subscriber the ability to access his/her HSA account and/or other financial accounts and/or lines-of-credit to pay for health care expenses; assisting in the preparation of tax forms for the subscriber; providing information related to providers of medical services and products, and qualified supplemental insurance, and with such information, providing an on-line shopping experience for the subscriber; facilitating the investment of HSA account funds into investment accounts; providing subscriber-authorized third-party temporary access to specified subscriber information; and generating statistical analysis reports.

The HSA-MP integration software module may be implemented in a variety of different communication systems. For instance, the HSA-MP integration software module may operate on a third-party host server separate from the financial institution server holding HSA account information, and separate from the health care insurer server holding health plan information. Alternatively, the HSA-MP integration module may reside within the financial institution local network, or within the health care insurer local network. The HSA-MP integration module may communicate with multiple insurers of the subscribers, as well as a third party administrator (TPA) administering health care claims for an employer of a subscriber.

Other aspects, features, and techniques of the invention will be apparent to one skilled in the relevant art in view of the following detailed description of the invention.

### BRIEF DESCRIPTION OF THE DRAWINGS

FIG. 1 illustrates a block diagram of an exemplary communication system in accordance with an embodiment of the invention;

FIG. 2 illustrates a flow diagram of an exemplary method of enrolling a subscriber for receiving services provided by the HSA-MP integration server in accordance with another embodiment of the invention;

FIG. 3 illustrates a flow diagram of an exemplary method of integrating and providing HSA account and health care plan information in accordance with another embodiment of the invention;

FIG. 4 illustrates a flow diagram of an exemplary method of facilitating the payment of a subscriber's medical expense with funds from the subscriber's HSA account in accordance with another embodiment of the invention;

FIG. 5 illustrates a flow diagram of an exemplary method of correlating transaction information with health care claims information in accordance with another embodiment of the invention;

FIG. 6 illustrates a flow diagram of an exemplary method of facilitating a payment of a subscriber's medical expense with funds from the subscriber's HSA account and/or with funds from other accounts and/or line-of-credit based on subscriber specified conditions in accordance with another embodiment of the invention;

FIG. 7 illustrate a flow diagram of an exemplary method of assisting a subscriber in completing a tax form in accordance with another embodiment of the invention;

FIG. 8 illustrates a flow diagram of an exemplary method of assisting a subscriber with purchasing medical services and/or products in accordance with another embodiment of the invention;

FIG. 9 illustrates a flow diagram of an exemplary method of facilitating the investment management of HSA account funds in accordance with another embodiment of the invention;

FIG. 10 illustrates a flow diagram of an exemplary method of providing a third party temporary access to certain information in the subscriber's data object in accordance with another embodiment of the invention;

FIG. 11 illustrates a flow diagram of an exemplary method of generating and providing a statistical analysis report concerning information in a plurality of subscribers data objects in accordance with another embodiment of the invention;

FIG. 12 illustrates a block diagram of another exemplary communication system in accordance with another embodiment of the invention;

FIG. 13 illustrates a block diagram of another exemplary communication system in accordance with another embodiment of the invention;

FIG. 14A illustrates a block diagram of another exemplary communication system in accordance with another embodiment of the invention;

FIG. 14B illustrates a block diagram of another exemplary communication system in accordance with another embodiment of the invention;

FIG. 15A illustrates a block diagram of another exemplary communication system in accordance with another embodiment of the invention;

FIG. 15B illustrates a block diagram of another exemplary communication system in accordance with another embodiment of the invention;

FIG. 16 illustrates a block diagram of an exemplary HSA-MP integration server in accordance with another embodiment of the invention;

FIG. 17 illustrates a screen shot of an exemplary Home webpage generated by the HSA-MP integration server in accordance with another embodiment of the invention;

FIG. 18 illustrates a screen shot of an exemplary Member Info webpage generated by the HSA-MP integration server in accordance with another embodiment of the invention;

FIG. 19 illustrates a screen shot of an exemplary My Benefits webpage generated by the HSA-MP integration server in accordance with another embodiment of the invention;

FIG. 20A illustrates a screen shot of an exemplary Healthcare Claims webpage generated by the HSA-MP integration server in accordance with another embodiment of the invention;

FIG. 20B illustrates a screen shot of an exemplary Healthcare Claims sub-webpage generated by the HSA-MP integration server in accordance with another embodiment of the invention;

FIG. 21A illustrates a screen shot of an exemplary HSA Activity webpage generated by the HSA-MP integration server in accordance with another embodiment of the invention;

FIG. 21B illustrates a screen shot of an exemplary HSA Activity sub webpage generated by the HSA-MP integration server in accordance with another embodiment of the invention;

FIG. 22A illustrates a screen shot of an exemplary Summary webpage generated by the HSA-MP integration server in accordance with another embodiment of the invention;

FIG. 22B illustrates a screen shot of an exemplary Summary sub-webpage generated by the HSA-MP integration server in accordance with another embodiment of the invention;

FIG. 22C illustrates a screen shot of an another exemplary Summary sub-webpage generated by the HSA-MP integration server in accordance with another embodiment of the invention;

FIG. 23A illustrates a screen shot of an exemplary Correspondence webpage generated by the HSA-MP integration server in accordance with another embodiment of the invention;

FIG. 23B illustrates a screen shot of an exemplary Correspondence sub-webpage generated by the HSA-MP integration server in accordance with another embodiment of the invention;

FIG. 24 illustrates a screen shot of an exemplary Help & FAQ webpage generated by the HSA-MP integration server in accordance with another embodiment of the invention;

FIG. 25A illustrates a screen shot of an exemplary Transaction webpage generated by the HSA-MP integration server in accordance with another embodiment of the invention; and

FIG. 25B illustrates a screen shot of an exemplary Transaction sub-webpage generated by the HSA-MP integration server in accordance with another embodiment of the invention.

### DETAILED DESCRIPTION OF THE INVENTION

I. Overview of the HSA-MP Integration Software Module

The invention relates to a health savings account—medical plan (HSA-MP) integration software module that integrates subscriber HSA account information with subscriber health plan information, provides the integrated information to the subscriber upon request, and performs a multitude of other functions. The HSA-MP integration software module, upon a subscriber enrolling for services, creates a subscriber data object for keeping track of both HSA account information and health plan information. The HSA-MP integration software module updates the subscriber data object each time it receives new HSA account information and/or health plan information. Since the HSA-MP integration software module constantly updates the subscriber data object, it provides current HSA account and health plan information to the subscriber upon request.

The HSA-MP integration software module also performs additional functions such as facilitating transactions for payment of medical claims with HSA account funds; correlating transaction information with claim information; providing a subscriber the ability to access his/her HSA account and/or other financial accounts and/or lines-of-credit to pay for health care expenses; assisting in the preparation of tax forms for the subscriber; providing the subscriber an on-line shopping feature for medical services and products, and qualified supplemental insurance; facilitating the investment of HSA account funds into investment accounts; providing subscriber-authorized third-party temporary access to specified subscriber information; and generating statistical analysis reports.

The HSA-MP integration software module may be implemented in a variety of different communication systems. For instance, the HSA-MP integration software module may operate on a third-party host server separate from the financial institution server holding HSA account information, and separate from the health care insurer server holding health plan information. Alternatively, the HSA-MP integration module may be housed within the financial institution local network, or within the health care insurer local network. The HSA-MP integration module may communicate with multiple insurers of the subscribers, as well as with a third party administrator (TPA) performing health claim administration for an employer of the subscriber.

II. Communication System Overview

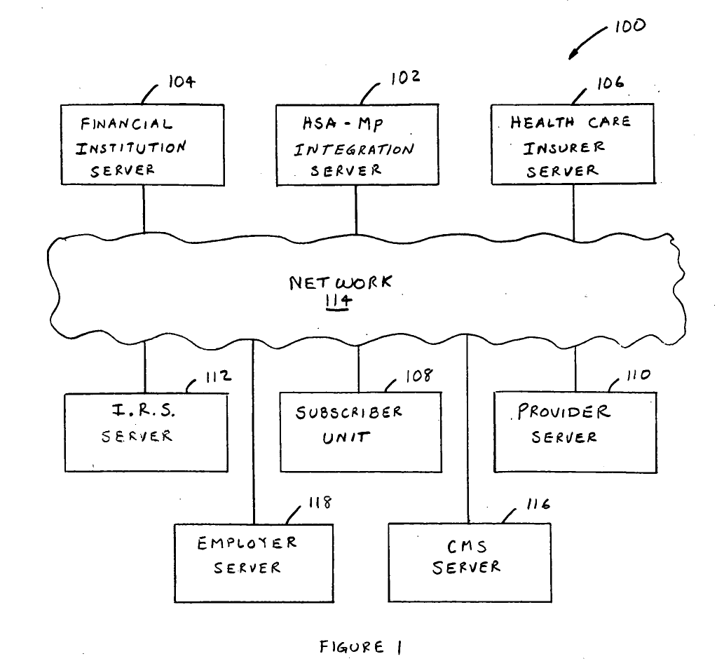

FIG. 1 illustrates a block diagram of an exemplary communication system 100 in accordance with an embodiment of the invention. The communication system 100 may comprise an HSA-MP integration server 102, a financial institution server 104, a health care insurer server 106, a subscriber unit 108, a provider server 110, an Internal Revenue Service (IRS) server 112, an employer server 118, and a Center for Medicare & Medicaid Services (CMS) server 116. All or some of these devices may communicate with each other by way of a network 114. It shall be understood that the communication system 100 may include a plurality of each of these devices.

The financial institution server 104 receives, stores, manipulates, and provides information related to health saving accounts (HSA) of subscribers. Such information may include, for example, the HSA account number, the name and contact information of the financial institution managing the HSA account, the subscriber's name and/or other personal information, the current balance in the HSA account, contributions to the HSA account made by the subscriber and/or his/her employer, interest accrued on the HSA account, withdrawals made from the HSA account, HSA funds transferred to an investment account, investment funds transferred back to the HSA account from an investment account, funds rolled over into the HSA account from another qualified account, and other HSA account related information.

It shall be understood that the invention is not limited to a specific type of account, such as the HSA account established by the 2003 Medicare Prescription Drug Bill, but encompasses any type of subscriber-directed, health care savings account that can be used to pay for qualified medical expenses on a full or partial tax exempt basis. Such type of health care savings accounts include Flexible Savings Accounts (FSAs), Healthcare Reimbursement Accounts (HRAs), and Medical Savings Accounts (MSAs). However, HSA accounts are used herein to exemplify the invention.

The health care insurer server 106 receives, stores, manipulates, and provides information related to health care plans of subscribers. Such information may include, for example, the health plan member number, the name and contact information of the health care insurer, the subscriber's name and/or other personal information, health plan benefits information including benefit maximums, the deductible, and co-payments, medical claims information including description of medical diagnosis and treatment provided to the subscriber and medical products such as prescription and/or over-the-counter drugs purchased by the subscriber, provider discount information, the amount of payments of medical expenses counting towards the deductible, the amount of withdrawals from the HSA account qualifying for tax exemption, information concerning providers of medical services and products, and other health care plan information.

As discussed in more detail below, the HSA-MP integration server 102 executes an HSA-MP software module that receives HSA account information pertaining to a subscriber from the financial institution server 104 by way of the network 114, receives health care plan information pertaining to a subscriber from the health care insurer server 106 by way of the network 114, and integrates both types of information into a subscriber data object. The HSA-MP integration server 102 provides the information, for example in the form of one or more webpage(s), to the subscriber unit 108, the employer server 118, and/or other third party by way of the network 114.

The HSA-MP integration server 102 may also perform additional functions such as facilitating transactions for payment of medical claims with HSA account funds; correlating transaction information with claim information; providing a subscriber the ability to access the his/her HSA account and/or other financial accounts and/or lines-of-credit to pay for health care expenses; assisting in the preparation of tax forms for the subscriber; providing information related to providers of medical services and products to the subscriber, and with such information, providing an on-line shopping experience for the subscriber; facilitating the investment of HSA account funds into investment accounts; providing subscriber-authorized third-party temporary access to specified subscriber information; and generating statistical analysis reports.

The provider server 110 may pertain to a medical facility that provides diagnosis and treatment to subscribers. Examples of medical facilities include hospitals, clinics, urgent care centers, physician offices, laboratories, radiologists, and others. The provider server 110 may also pertain to a pharmacy or other entities selling medical products such as prescription and/or over-the-counter drugs to subscribers. The provider server 100 receives, stores, and provides claim information related to medical services provided to subscribers and/or medical products purchased by subscribers. The provider server 110 may provide such medical claim information to the health care insurer server 106 by way of the network 114 for payment thereof by the health care insurer.

The IRS server 112 receives, stores, manipulates, and provides information related to the payment of Federal taxes. As discussed above and in more detail below, the HSA-MP integration server may assist subscribers in completing tax forms. For tax purposes, the HSA-MP integration server 102 may provide the requested HSA account information to the subscriber unit 108 by way of the network 114.

The subscriber unit 108 is a device used by a subscriber that is capable of retrieving and interacting with one or more webpages generated by the HSA-MP integration server 102 by way of the network 114. Examples of subscriber units include desktop computers, laptop computers, personal digital assistants (PDAs), landline telephones, cellular telephones, and other devices.

The employer of the subscriber, through the employer server 118, may make financial contributions to the subscriber's HSA account typically on a periodic basis (e.g., monthly, quarterly, annually, etc.). This may be accomplished electronically by the employer server 118 sending an electronic deposit to the financial institution server 104 by way of the network 114. Alternatively, the deposit may be made using a payroll processing firm. In addition, with the approval of the subscriber, the employer server 118 may retrieve information (e.g., authorized webpage(s) containing limited information) from the HSA-MP integration server 102 by way of the network 114.

The CMS server 116 may provide information related to providers of medical services and/or products to the HSA-MP integration server 102 by way of the network 114. The HSA-MP integration server 102 may use the providers information to implement an on-line shopping service for subscribers as discussed above. This allows subscribers to be in more control of managing their medical expenses and their HSA account.

The network 114 may be any type of computer network that is able to facilitate the transfer of digital data between the various servers and units connected to the network 114. Examples of such network 114 include the Internet, a wide area network (WAN), an intranet, a local area network (LAN), a hardware interface (e.g., a Universal Serial Bus (USB) interface), a software interface, and others. The network 114 need not comprise a single type network, but can be different types of interfaces connecting any combination of the servers and units. As is exemplified further below, the HSA-MP integration server 102 and the financial institution server 104 may be connected to each other by a LAN, hardware interface, or software interface; and the health care insurer server 106 may be connected to the HSA-MP integration server 102 by way of the Internet; or vice-versa.

III. Enrollment—Creating a New Subscriber Data Object

The HSA-MP integration server 102 creates a data object for each subscriber for storing, accessing and manipulating the subscriber's HSA account information and health plan information. The HSA-MP integration server 102 creates the subscriber data object at the time the subscriber enrolls for services provided by the HSA-MP integration server 102. The following describes an exemplary method of enrolling a subscriber and the creation of a subscriber data object.

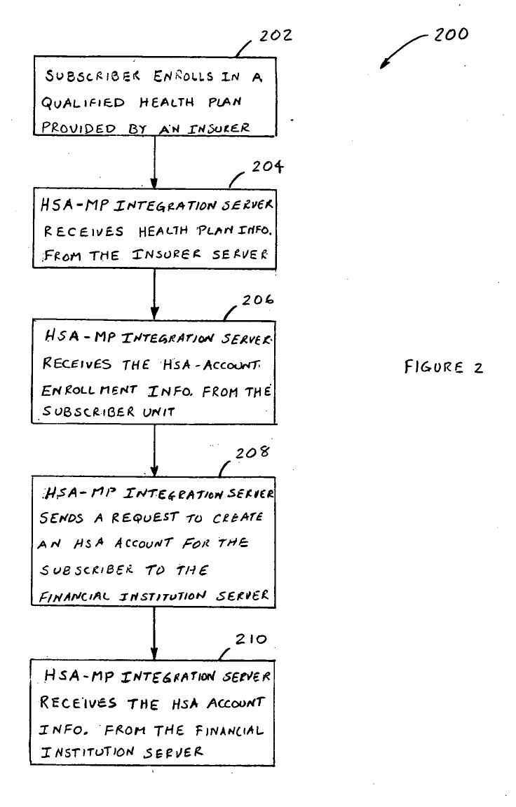

FIG. 2 illustrates a flow diagram of an exemplary method 200 of enrolling a subscriber for receiving services provided by the HSA-MP integration server 102 in accordance with another embodiment of the invention. According to the method 200, a subscriber enrolls in a qualified health plan provided by a health care insurer (block 202). There are many ways that a subscriber can enroll for such a qualified health plan. For instance, the subscriber himself can enroll for the plan, or the subscriber's employer can enroll the subscriber into the plan.

After the subscriber enrolls in the health plan, the HSA-MP integration server 102 receives some or all of the subscriber's health plan information from the health care insurer server 106 by way of the network 114 (block 106). The HSA-MP integration server 102 may receive this information individually for that particular subscriber, or may receive the information in a batch which includes information pertaining to many subscribers. At this point, the HSA-MP integration server 102 may create a subscriber data object for storing information related to the subscriber's HSA account and the health plan related information.

After the HSA-MP integration server 102 receives the subscriber's health plan information and creates the subscriber data object, the HSA-MP integration server 102 receives the subscriber's HSA account enrollment information from the subscriber unit 108 by way of the network 114 (block 206). In this regard, the subscriber using the subscriber unit 108 accesses an HSA account enrollment webpage generated by the HSA-MP integration server 102. The subscriber then enters all of the pertinent information and submits the enrollment information. Alternatively, the HSA-MP integration server 102 may have already pre-populated the enrollment form with some or all of the requested information since it may have obtained such information from the health care insurer server 106. In such case, the subscriber just needs to verify (or change, if incorrect) the information and then submit the populated enrollment form. The enrollment information is then sent to the HSA-MP integration server 102 by way of the network 114. The HSA-MP integration server 102 verifies the enrollment information with the information in the subscriber data object, and flags the data object to note that the subscriber has submitted the enrollment form.

After the HSA-MP integration server 102 has received the HSA account enrollment information, the HSA-MP integration server 102 sends a request to create an HSA account for the subscriber to the financial institution server 104 by way of the network 114 (block 208). The request contains some or all of the enrollment information provided to the HSA-MP integration server 102 by the subscriber unit 108. The financial institution uses this information to create an HSA account for the subscriber.

After the financial institution server 104 receives the request to create an HSA account and the HSA account is created, the HSA-MP integration server 102 receives information related to the identity of the HSA account from the financial institution server 104 (block 210). The HSA-MP integration server 102 updates the subscriber data object to include the information related to the identity of the HSA account. The financial institution may mail the subscriber signature cards for the account, to be signed and returned to the financial institution by the subscriber. Alternatively, the HSA enrollment form generated by the HSA-MP integration server 102 may provide a manner for the subscriber to submit an electronic signature.

The above enrollment method 200 is merely one example of how a subscriber may enroll for receiving services provided by the HSA-MP integration server 102. There are many other ways for the subscriber to enroll. For example, the subscriber may enroll through a website provided by the financial institution, or through a website provided by the health care insurer. Whichever method is utilized, the enrollment process results in the HSA-MP integration server 102 creating a subscriber data object for use in storing, accessing, and manipulating information related to the subscriber's HSA account and the subscriber's health plan. As discussed below, the subscriber data object serves as a depository of new data related to changes in the information related to the subscriber's HSA account and the subscriber's health plan.

IV. Integration—Updating a Subscriber Data Object

Once the HSA-MP integration server 102 creates a data object for a subscriber, it updates the information in the subscriber's data object when it receives new HSA account information and/or health plan information pertaining to the subscriber. In doing so, the HSA-MP integration server 102 keeps the information in the subscriber data object relatively current. Upon receiving a request for information from the subscriber, the HSA-MP integration server 102 may dynamically generate one or more webpages containing the requested information. The following describes an exemplary method of integrating and providing HSA account and health care plan information to a subscriber.

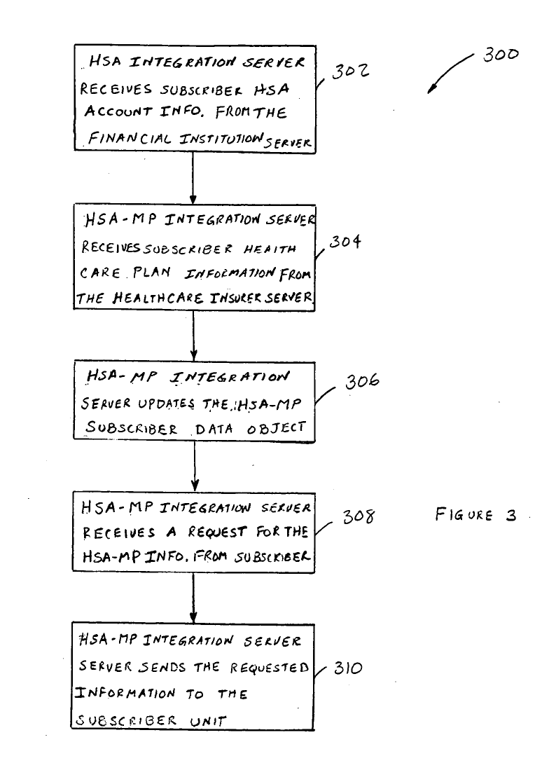

FIG. 3 illustrates a flow diagram of an exemplary method 300 of integrating and providing HSA account and health care plan information in accordance with another embodiment of the invention. According to the method 300, the HSA-MP integration server 102 receives information related to the subscriber's HSA account from the financial institution server 104 by way of the network 114 (block 302). The information may include, for example, the current balance of the HSA account, contributions made to the account by the subscriber and/or his/her employer, interest accrued on the account, HSA investment funds transferred back to the HSA account, withdrawals from the account for payment of qualified medical expenses and/or unqualified expenses, HSA funds transferred to investment accounts, funds rolled over into the HSA account from another qualified account, and other HSA account related information. The HSA-MP integration server 102 may receive the HSA account information on a periodic basis, such as on a daily basis, or on a “real time” basis, such as at the approximate time the information has changed.

Similarly, the HSA-MP integration server 102 receives information related to the subscriber's health plan from the health care insurer server 106 by way of the network 114 (block 302). The information may include, for example, benefit maximums, deductible, co-payments, medical claims information including a description of medical services provided to the subscriber and/or medical products purchased by the subscriber, provider discount information, the itemized billed amounts for such medical services and/or products, the itemized amounts of such bills that count towards the deductible, the tax exempt qualification status associated with those medical services and/or products, the itemized payment status of the medical claims, dates associated with the medical claims, changes to health plan coverage, and other subscriber health plan information. The HSA-MP integration server 102 may receive the health plan related information on a periodic basis, such as on a daily basis, or on a “real time” basis, such as at the approximate time the information has changed.

After the HSA-MP integration server 102 has received the subscriber's HSA-account and/or health plan information, the HSA-MP integration server 102 updates the subscriber data object to reflect the new information (block 306). In this manner, the information in the subscriber data object is kept relatively current. This allows the subscriber to make decisions regarding his/her HSA account and health plan on current information.

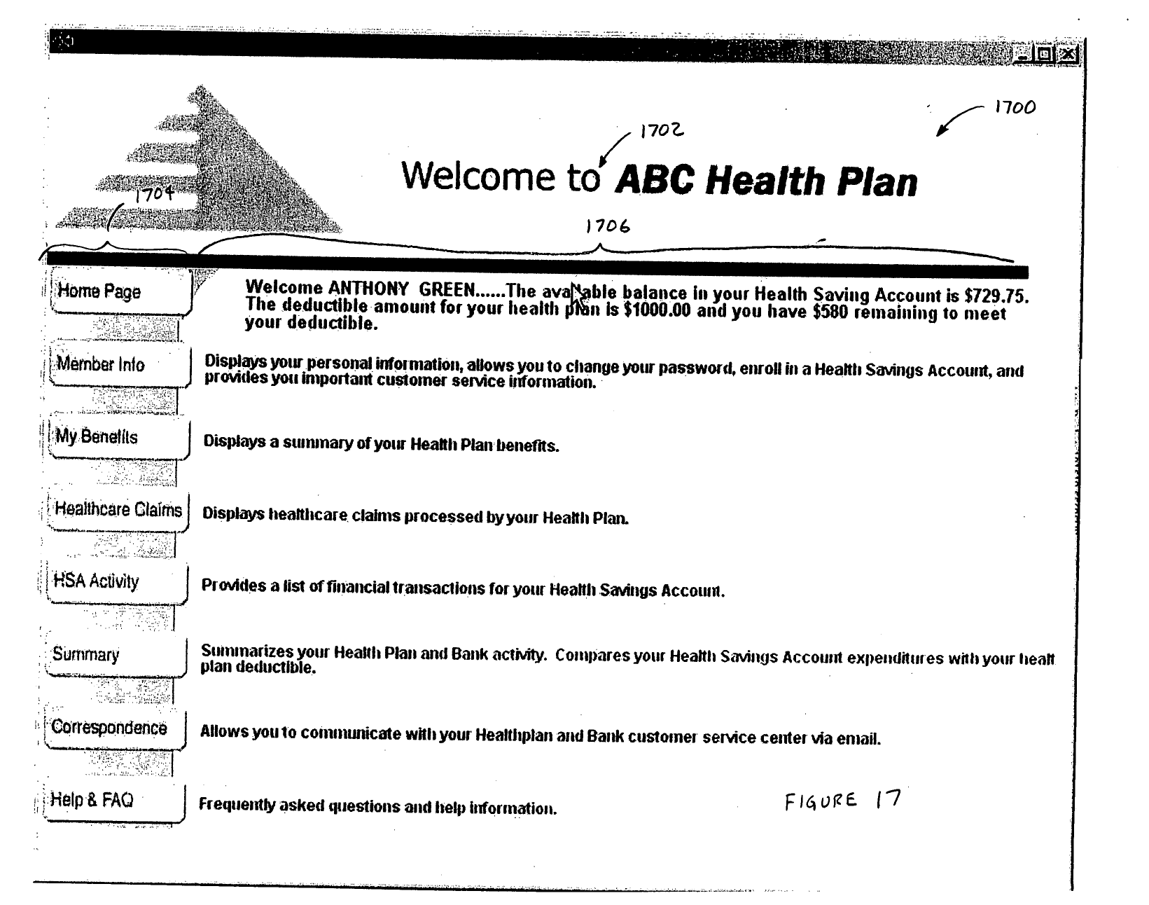

At a particular time, the HSA-MP integration server 102 may receive a request for the information in the subscriber data object from the subscriber unit 108 by way of the network 114 (block 308). In this regard, the subscriber using a web browser running on the subscriber unit 108 may access an access-webpage generated by the HSA-MP integration server 102. The subscriber may enter a username and password to obtain access to one or more webpages that contain the information in the subscriber data object. As described in the sample webpages shown in FIGS. 17 through 25B, the HSA-MP integration server 102 integrates and manipulates the HSA account and health plan information to provide useful information that the subscriber can use in managing his/her HSA account and health plan, such as the amount of withdrawals from the HSA account that went towards qualified and unqualified expenses, the amount of withdrawals from the HSA account that went towards the deductible, etc.

After the HSA-MP integration server 102 receives the request for the information and has verified the subscriber's username and password, the HSA-MP integration server 102 provides the information in the subscriber data object to the subscriber unit 108 by way of the network 114 (block 310). In this regard, the HSA-MP integration server 102 populates one or more template webpages with the information in the subscriber data object, and sends the one or more webpages (e.g., HTML files) to the subscriber unit 108 by way of the network 114. The subscriber may view the one or more webpages using a web browser running on the subscriber unit 108. Thus, the subscriber has the ability to access current information related to both his/her HSA account and health plan easily by accessing webpages provided by the HSA-MP integration server 102.

V. Transaction—Facilitating the Payment of Medical Claims

Since the HSA-MP integration server 102 communicates with the financial institution server 104 in receiving HSA account information and communicates with the health care insurer server 106 in receiving health plan information, the HSA-MP integration server 102 may also facilitate the making of transactions related to the payment of medical claims with funds from the HSA account funds and/or other account(s) and/or line(s)-of-credit. In this regard, the HSA-MP integration server 102 receives claim information and a request for payment from the health care insurer server 106, requests approval from the subscriber to pay the insurer with HSA account funds, and sends a transaction request to the financial institution. The following describes an exemplary method of facilitating the payment of a subscriber's medical expense with funds from the subscriber's HSA account.

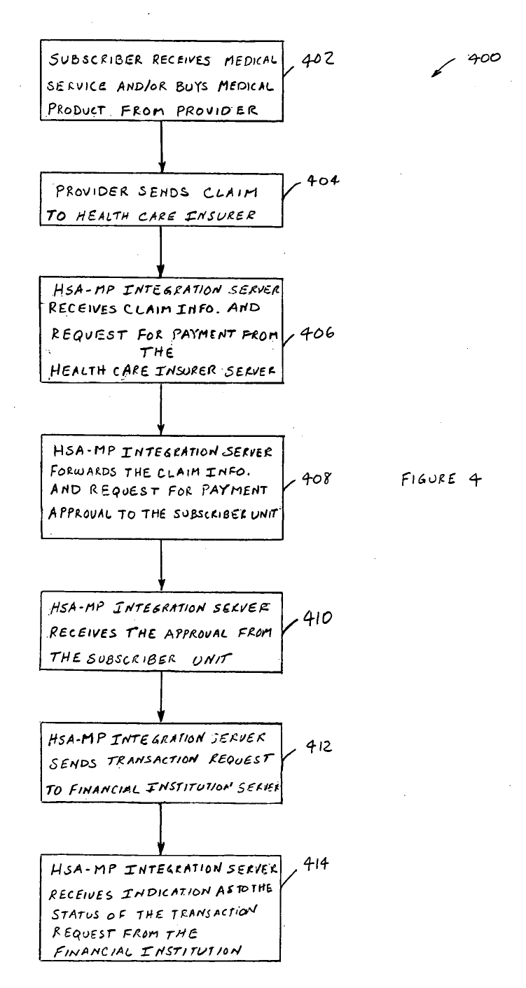

FIG. 4 illustrates a flow diagram of an exemplary method 400 of facilitating a payment of a subscriber's medical expense with funds from the subscriber's HSA account in accordance with another embodiment of the invention. According to the method 400, the subscriber receives medical services and/or purchases medical products (e.g., prescription drugs) at a provider facility (e.g., a hospital, doctor's office, pharmacy) (block 402). The provider facility may send the claim information related to the medical services and/or product from the provider server 110 to the health care insurer server 106 by way of the network 114 (block 404).

The HSA-MP integration server 102 then receives the claim information and a request for payment of the claim from the health care insurer server 106 by way of the network 114 (block 406). The claim information may include the date the subscriber received the medical services and/or purchased the medical product, a claim number associated with the claim, a description of the provider, the claim amount, the amount of the claim which counts towards the deductible, the tax exempt qualification status associated with the medical services and/or product, and other health care plan information. The HSA-MP integration server 102 then updates the subscriber data object to reflect the new claim information.

After the claim information and payment request has been received, the HSA-MP integration server 102 forwards the claim information and payment approval request to the subscriber unit 108 (block 408). In this regard, the HSA-MP integration server 102 may send an email to the subscriber with a link to a webpage containing the claim information and an input object to receive an approval for payment of the claim. The subscriber using a web browser running on the subscriber unit 108 accesses the webpage and submits an approval for payment of the claim to the HSA-MP integration server 102 via the network 114.

After receiving approval for payment of the claim, the HSA-MP integration server 102 sends a transaction request to the financial institution server 104 by way of the network 114, requesting payment of the claim from the subscriber's HSA account to the health care insurer's account (block 412). Such a transaction request may be made in accordance with the Automated Clearing House (ACH) protocol. After the transaction request has been sent, the HSA-MP integration server 102 may receive an indication as to whether the transaction request was approved or denied (block 414). The HSA-MP integration server 102 then updates the subscriber data object to reflect the status of the transaction request. Thus, the HSA-MP integration server 102 facilitates the payment of the subscriber's medical expenses.

VI. Correlating Transaction Information with Claim Information

In some cases, a subscriber may pay an insurer and/or provider directly (without the assistance of the HSA-MP integration server 102) with funds from his/her HSA account, using for example a credit or debit card tied to the HSA account. In such a case, the HSA-MP integration server 102 receives separately the corresponding transaction information from the financial institution server 104 and the corresponding claim information from the health care insurer server 106. To match the transaction with the claim, the HSA-MP integration server 102 has to correlate information. Accordingly, the following describes an exemplary method of correlating transaction information with health care claims information.

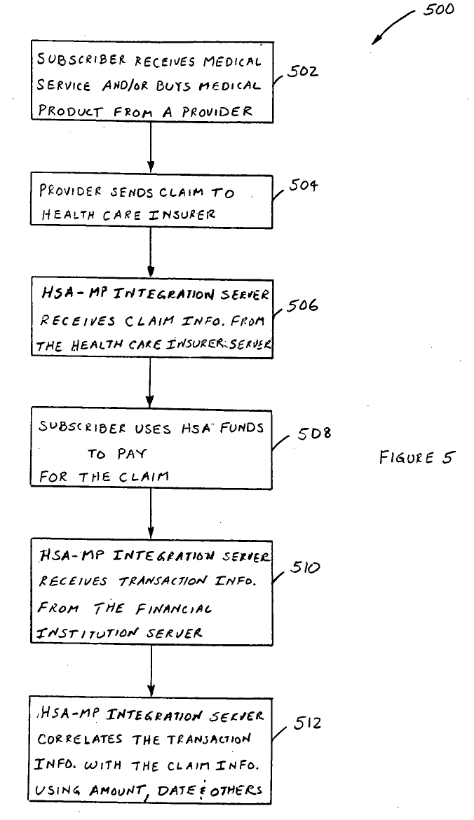

FIG. 5 illustrates a flow diagram of an exemplary method 500 of correlating transaction information with health care claims information in accordance with another embodiment of the invention. According to the method 500, the subscriber receives medical services and/or purchases medical products (e.g., prescription drugs) at a provider facility (e.g., a hospital, doctor's office, pharmacy) (block 502). The provider facility may send the claim information related to the medical services and/or product from the provider server 110 to the health care insurer server 106 by way of the network 114 (block 504).

The HSA-MP integration server 102 then receives the claim information from the health care insurer server 106 by way of the network 114 (block 506). As discussed above, the claim information may include the date the subscriber received the medical services and/or purchased the medical product, a claim number associated with the claim, a description of the provider, the claim amount, the amount of the claim which counts towards the deductible, the tax exempt qualification status associated with the medical services and/or product, and other health care plan information. The HSA-MP integration server 102 then updates the subscriber data object to reflect the new claim information.

The subscriber then pays the health care insurer and/or provider directly for the claim using funds from the subscriber's HSA account (block 508). For example, the subscriber may use a debit card or check associated with the HSA account to make the payment to the health care insurer. After the financial institution has approved and completed the transaction, the HSA-MP integration server 102 receives the transaction information from the financial institution server 104 by way of the network 114 (block 510). The HSA-MP integration server 102 updates the subscriber data object to reflect the new transaction information, and correlates the transaction information with the corresponding claim information using various parameters, such as the transaction-claim amount, transaction-claim dates, and other parameters (block 512).

VII. Other Financial Accounts and Lines-of-Credit

In some cases, a subscriber's medical expenses related to a claim may exceed the current balance in the HSA account. If the HSA-MP integration server 102 takes automatic action to pay the claim with HSA account funds, the transaction request may be denied because of insufficient funds. To address this issue, the HSA-MP integration server 102 provides a feature that allows a subscriber to setup backup accounts and/or lines-of-credit, and conditions for their uses. Accordingly, the following describes an exemplary method of facilitating the payment of a subscriber's medical expense with funds from the subscriber's HSA account, non-HSA account, and/or line-of-credit based on specified conditions.

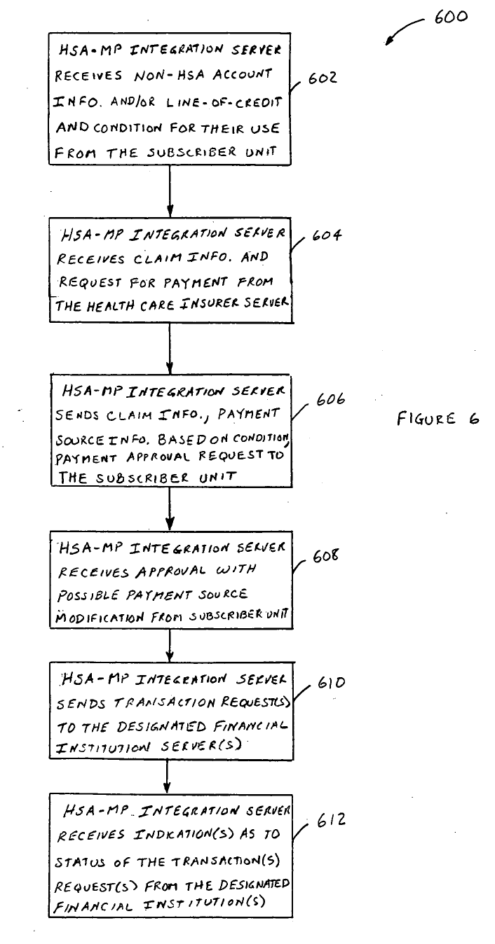

FIG. 6 illustrates a flow diagram of an exemplary method 600 of facilitating a payment of a subscriber's medical expense with funds from the subscriber's HSA account and/or from other non-HSA accounts and/or lines-of-credit based on subscriber-specified conditions in accordance with another embodiment of the invention. According to the method 600, the HSA-MP integration server 102 receives non-HSA account and/or line-of-credit information, and conditions for their use for payment of medical claims from the subscriber unit 108 via the network 114 (block 602). The non-HSA account may be a regular savings account, checking account, mutual fund account or any other financial account. These accounts need not reside with the financial institution managing the HSA account. Similarly, the line-of-credit need not be set up with the financial institution providing the HSA account.

In this regard, the HSA-MP integration server 102 may generate a webpage which allows the subscriber to enter such non-HSA account and line-of-credit information, and conditions for their use. For example, the subscriber may want to establish a hierarchical account withdrawal condition for payment of medical claims. For instance, the subscriber may want to first withdraw funds from the HSA account until its balance reaches a minimum threshold to pay a first portion of the medical claim, then withdraw funds from the subscriber's checking account until its balance reaches a minimum threshold to pay for a second portion of the medical claim, and then use the line-of-credit to pay for the remaining portion of the medical claim.

Once these backup sources for payment of medical claims have been setup, the HSA-MP integration server 102 may subsequently receive claim information and a request for payment from the health care insurer server 106 via the network 114 (block 604). Such claim information may pertain to prior medical services received by the subscriber and/or medical products purchased by the subscriber. For example, the claim may pertain to a back surgery performed on the subscriber and a claim amount of $2000. In this example, the subscriber has not met the deductible.

The HSA-MP integration server 102 then sends the claim information, payment source information based on the condition(s), and payment approval request to the subscriber unit 108 via the network 114 (block 606). In this example, the HSA-MP integration server 102 determines that, according to the payment source condition, $1000 of the claim is to be paid from funds in the subscriber's HSA account with financial institution A, $500 of the claim amount is to be paid from funds in the subscriber's checking account with financial institution B, and $500 is to be paid from a line-of-credit established with financial institution C. The HSA-MP integration server 102 may provide such information and an approval input object to the subscriber unit 108 via an email with a link to a webpage containing the information and approval input object.

The HSA-MP integration server 102 then receives approval for payment of the claim with a possible payment source modification from the subscriber unit 108 via the network 114 (block 608). In this regard, using the webpage generated by the HSA-MP integration server 102 the subscriber may choose to approve the payment of the claim with the payment sources as designated (e.g., $1000 from the HSA account, $500 from the checking account, and $500 from the line-of-credit). Alternatively, the subscriber, using the webpage, may choose to modify the payment sources (e.g., $800 from HSA account, $800 from the checking account, and $400 from the line-of-credit), and approve the payment of the claim using the modified payment sources.

Once the HSA-MP integration server 102 has received the payment approval and the designated payment sources, the HSA-MP integration server 102 sends a transaction request(s) to the financial institution(s) involved in payment of the claim by way of the network 114 (block 610). Thus, in this example, the HSA-MP integration server 102 sends three transaction requests, i.e., to financial institutions A, B, and C. At a later time, the HSA-MP integration server 102 receives indication(s) as to the status of the transaction request(s) from the designated financial institution(s) via the network 114 (block 612). The HSA-MP integration server 102 updates the subscriber data object to reflect the status of the transaction request. Thus, the HSA-MP integration server 102 provides a feature by which the subscriber can designate other backup sources for the payment of medical expenses.

VIII. Tax Form Preparation Assistance

Since an HSA account is subscriber-directed allowing the subscriber to use funds in any manner, the subscriber may use the funds for qualified (tax exempt) or unqualified (non-tax exempt) purchases. Since the HSA-MP integration server 102 receives and stores HSA account transaction information, it holds information useful for tax purposes. Thus, it is able to provide such useful tax information to a subscriber upon request. The following describes an exemplary method of assisting a subscriber in the preparation of a tax form.

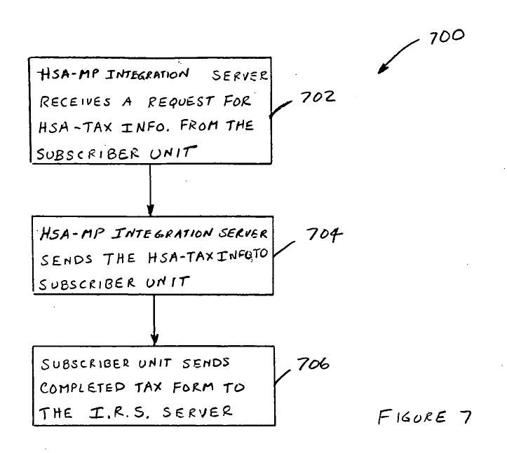

FIG. 7 illustrates a flow diagram of an exemplary method 700 of assisting a subscriber in completing a tax form in accordance with another embodiment of the invention. According to the method 700, the HSA-MP integration server 102 receives a request for HSA account, tax-related information from the subscriber unit 108 by way of the network 114 (block 702). The HSA account, tax-related information may include, for example, the amount of withdrawals from the HSA account that went towards tax exempt purchases (e.g., qualified medical expenses), and the amount of withdrawals from the HSA account that went towards non-tax exempt purchases (e.g., purchasing a set of golf clubs). The HSA-MP integration server 102 may be able to interface with tax form preparation software, such as Quicken®, TurboTax®, and others. In such case, the HSA-MP integration server 102 recognizes the format of the request.

After receiving the request for the HSA account, tax-related information, the HSA-MP integration server 102 accesses the HSA account, tax-related information from the subscriber data object, and sends the information to the subscriber unit 108 via the network 114 (block 704). Again, the HSA-MP integration server 102 may be able to interface with tax form preparation software, such as Quicken, TurboTax, and others. Thus, the HSA-MP integration server 102 formats the information in accordance with the software it is interfacing with, and then sends the formatted information to the subscriber unit 108 by way of the network 114. Alternatively, or in addition to, the HSA-MP integration server 102 may generate a standard tax reporting form containing the pertinent information and provide it to the subscriber unit 108 via the network 114. The subscriber unit 108 may use the received information to complete and submit the tax form to the I.R.S. server 112 via the network 114 (block 706).

IX. Medical Services and Products On-Line Shopping

As discussed above, since an HSA account is subscriber-directed allowing the subscriber to use the funds in any manner, many subscribers may want to make the most efficient use of his/her HSA funds. In doing so, a subscriber may desire to do some comparison shopping to obtain the medical services and/or products from desirable providers at a desirable price. In addition, the subscriber may desire information related to qualified supplemental insurance. The HSA-MP integration server 102 is capable of receiving provider information including fee schedules and providing an on-line shopping experience for subscribers. Accordingly, the following describes an exemplary method of assisting a subscriber in the purchase of medical services and/or products.

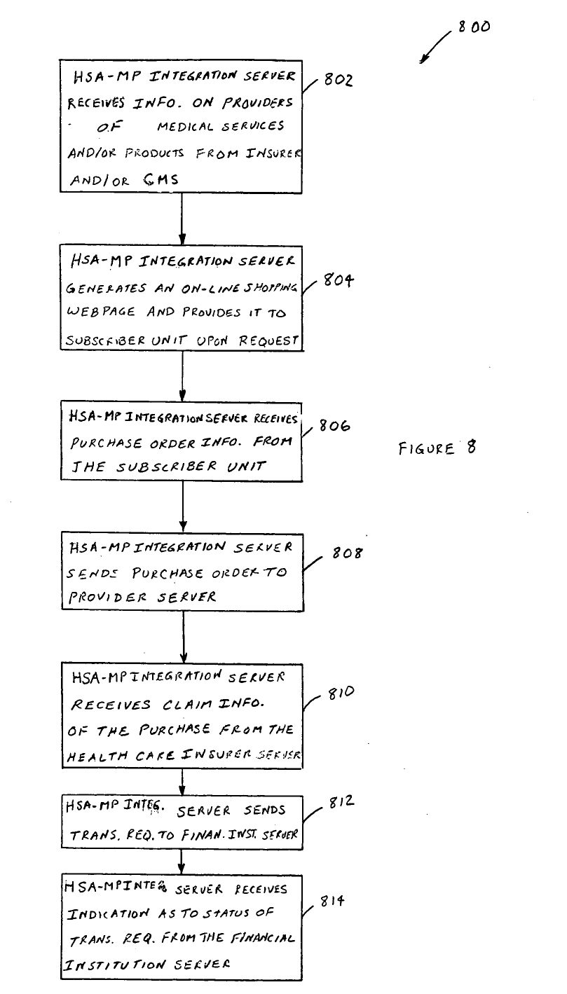

FIG. 8 illustrates a flow diagram of an exemplary method 800 of assisting a subscriber in purchasing medical services and products insurance in accordance with another embodiment of the invention. According to the method 800, the HSA-MP integration server 102 receives information related to providers of medical services and products from the health care insurer server 106, CMS server 116, and other sources via the network 114 (block 802).

The provider information may include, for example, physician name and contact information, the physicians' respective practice areas, the physicians' qualifications (e.g., years-of-experience and education), patient reviews of the physicians, fees the respective physicians charge for standard medical procedures, deductibility associated with the medical services based on the subscriber's health plan, and other information that is useful to a subscriber in selecting a provider. The provider information may further include information about sellers of medical products (e.g., pharmacies), generic products and corresponding non-generic products, providers' respective retail prices for medical products, deductibility associated with the medical products based on the subscriber's health plan, and other information that is useful to a subscriber in deciding which product to purchase.

The HSA-MP integration server 102 stores the provider information in a database, and generates one or more on-line shopping webpage(s) containing the provider information and/or pertinent subscriber health plan information which can be accessed by the subscriber unit 108 via the network 114 (block 804). The centralized location of the provider information facilitates the subscriber in making informed decisions as to which medical services and/or medical products to purchase based on provider qualitative and cost information, and the subscriber's health plan and HSA account information.

The HSA-MP integration server 102 then receives purchase order information from the subscriber unit 108 via the network 114 (block 806). In this regard, the subscriber scrolls through the on-line webpage(s) to view the medical services and/or medical product information. Using an input object provided by the webpage(s), the subscriber then selects the medical services and/or products he/she wishes to purchase. The HSA-MP integration server 102 may provide a “shopping cart” to keep track of such selections. Then, once the subscriber has chosen all services/products to purchase, he/she submits the purchase order using the input object.

The HSA-MP integration server 102 then sends the purchase order to the provider server 110 pertaining to the purchased medical services and/or medical products via the network 114 (block 808). For example, if the provider is a doctor's office, the HSA-MP integration server 102 may send an email to the doctor's office containing the subscriber's contact information and a request for an appointment to see the doctor. The doctor's office may then contact the subscriber to setup the appointment. As another example, if the provider is a pharmacy, the HSA-MP integration server 102 may send a purchase order to the pharmacy with the subscriber's contact information and health plan information. In this example, the HSA-MP integration server 102 may wait for a claim to be received from the health care insurer server 106 for the purchase before commencing the transaction process, or forego the wait and commence the transaction by sending a transaction request for the purchase to the financial institution 104 as previously discussed, and send a notification of the purchase to the health care insurer server 106 via the network 114.

If the HSA-MP integration server 102 waits before commencing the transaction, at a later time it receives the claim information and request for payment associated with the purchase from the health care insurer server 106 via the network 114 (block 810). The HSA-MP integration server 102 updates the subscriber data object with the claim information. At this point, the HSA-MP integration server 102 may request approval from the subscriber for payment of the claim, as previously discussed. Or, the HSA-MP integration server 102 may proceed with the payment of the claim since in this scenario the subscriber had already submitted the purchase order, and therefore the HSA-MP integration server 102 may see it as an implicit approval to pay the claim.

The HSA-MP integration server 102 then sends a transaction request to the financial institution server 104 by way of the network 114, requesting payment of the claim from the subscriber's HSA account to the health care insurer's account (block 812). Such a transaction request may be made in accordance with the Automated Clearing House (ACH) protocol. After the transaction request has been sent, the HSA-MP integration server 102 may receive an indication as to whether the transaction request was approved or denied (block 814). The HSA-MP integration server 102 then updates the subscriber data object to reflect the status of the transaction request. Thus, the HSA-MP integration server 102 facilitates the informed purchasing and the payment of a subscriber's medical expenses.

X. Facilitating Investment of HSA Funds into Investment Accounts

As discussed above, since an HSA account is subscriber-directed allowing the subscriber to use the funds in any manner, many subscribers may want to make the most efficient use in preserving his/her HSA funds. In doing so, the subscriber may want to transfer funds in his/her HSA account into possibly higher earning investment accounts. The HSA-MP integration server 102 provides a feature to facilitate the transfer of HSA funds to and from other investment accounts. Accordingly, the following describes an exemplary method of facilitating the investment management of HSA account funds.

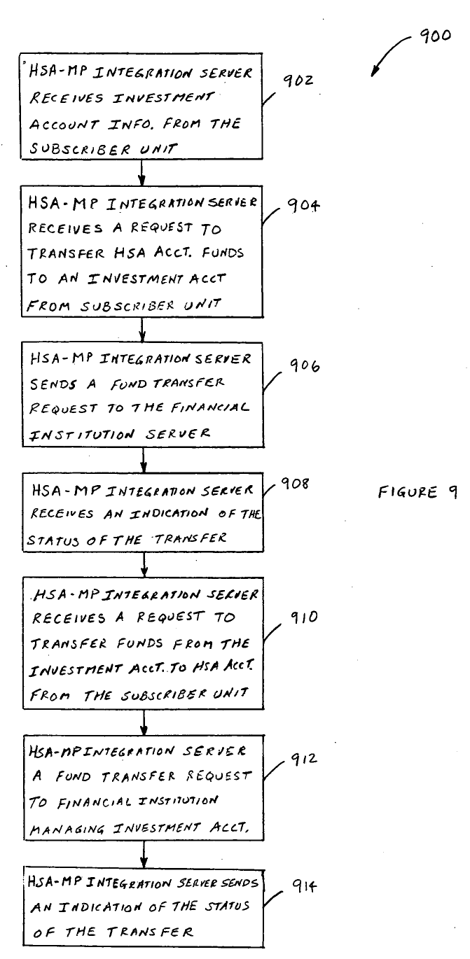

FIG. 9 illustrates a flow diagram of an exemplary method 900 of facilitating the investment management of HSA account funds in accordance with another embodiment of the invention. According to the method 900, the HSA-MP integration server 902 receives investment account information from the subscriber unit 108 via the network 114 (block 902). In this regard, the HSA-MP integration server 102 may generate a webpage with an input object for receiving investment account(s) information from a subscriber. The subscriber, using a web browser running on the subscriber unit 108, can access the webpage and enter and submit the investment account(s) information.

The HSA-MP integration server 102 may also receive a request to transfer funds from the subscriber's HSA account to one or more investment account(s) from the subscriber unit 108 via the network 114 (block 904). In this regard, the HSA-MP integration server may generate a webpage with an input object, which may be the same webpage discussed in the previous paragraph, to receive a request to transfer funds from the subscriber's HSA account to the one or more investment account(s). The subscriber, using a web browser running on the subscriber unit 108, can access the webpage and enter the HSA fund amount(s) and to which respective investment account(s) the amount(s) will be transferred.

The HSA-MP integration server 102 then sends one or more fund transfer request(s) for transferring the designated amount(s) from the HSA account to the investment account(s) to the financial institution server 104 via the network 114 (block 906). If the request(s) can be met, the financial institution performs the requested fund transfer(s). The HSA-MP integration server 102 then receives an indication as to the status of the transfer(s) from the financial institution server 104 by way of the network 114 (block 908). The HSA-MP integration server 102 then updates the subscriber data object to reflect the status of the transfer(s).

At a later time, the HSA-MP integration server 102 may receive a request to transfer funds from the investment account(s) to the subscriber's HSA account from the subscriber unit 108 via the network 114 (block 910). In this regard, the HSA-MP integration server 102 may generate a webpage with an input object to receive a request to transfer funds from the investment account(s) to the subscriber's HSA account. The subscriber, using a web browser running on the subscriber unit 108, can access the webpage and enter the investment fund amount(s) and from which respective investment account(s) the amount(s) will be transferred.

The HSA-MP integration server 102 then sends one or more fund transfer request(s) for transferring the designated amount(s) from the investment account(s) to the HSA account to the financial institution(s) managing the investment account(s) via the network 114 (block 912). If the request(s) can be met, the financial institution(s) performs the requested fund transfer(s). The HSA-MP integration server 102 then receives an indication as to the status of the transfer(s) from the financial institution(s) by way of the network 114 (block 914). The HSA-MP integration server 102 then updates the subscriber data object to reflect the status of the transfer(s).

The HSA-MP integration server 102 may receive information related to the investment account(s) from the corresponding financial institution(s) via the network 114. Upon receiving a request for this information from the subscriber unit 108 via the network 114, the HSA-MP integration server 102 may dynamically generate one or more webpage(s) containing the investment account(s) information, and transmit the one or more webpage(s) to the subscriber unit 108 via the network 114. This facilitates the subscriber in managing his/her investment account(s) in addition to managing his/her HSA account.

XI. Providing Authorized Third Party Access to Subscriber Information

Because HSA accounts are relatively new and complex, a subscriber may sometimes need assistance with understanding and managing the HSA account information and corresponding health plan information. In such a case, a subscriber may seek the assistance of an employer or other third party. Additionally, an employer may desire to view information in an employee's HSA account. Therefore, the HSA-MP integration server 102 provides a feature which allows a subscriber to grant temporary access to specified subscriber information to a third party. Accordingly, the following describes an exemplary method of providing a third party temporary access to certain information in the subscriber data object.

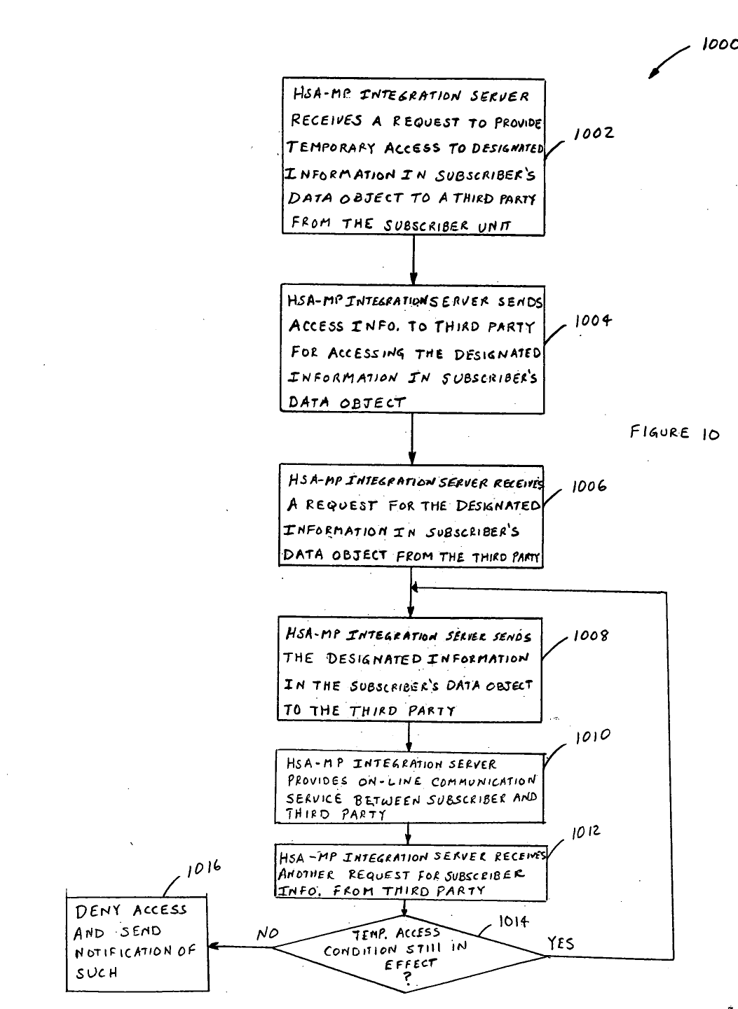

FIG. 10 illustrates a flow chart of an exemplary method 1000 of providing a third party temporary access to certain information in the subscriber data object in accordance with another embodiment of the invention. According to the method 1000, the HSA-MP integration server 1002 receives a request to provide temporary access to designated information in the subscriber data object to a third party (e.g., the subscriber's employer) from the subscriber unit 108 via the network 114 (block 1002). In this regard, the subscriber, using a web browser running on the subscriber unit 108, access a webpage generated by the HSA-MP integration server 102 with an input object to receive, for example, information concerning the third party (e.g., the third party's email address), the designated information in the subscriber data object (e.g., the subscriber's HSA account information), and a duration of time for which the third party is able to temporarily access the information (e.g., 2 days). Using the webpage, the subscriber enters and submits the requested inputs.

Then, the HSA-MP integration server 102 sends the access information to the designated information in the subscriber data object to the third party (e.g., to the employer server 118) via the network 114 (block 1004). In this regard, the HSA-MP integration server 102 may send an email to the third party via the network 114 containing a temporary username/password, and a link to a webpage having an input object to receive the username/password.

The HSA-MP integration server 102 then receives a request for the designated information in the subscriber data object from the third party via the network 114 (block 1006). In this regard, the third party, using an email program to view the email and click the link to the webpage, and a web browser to access the webpage, enters the temporary username/password into the input object. If the request is received within the designated temporary time period, the HSA-MP integration server 102 generates and sends one or more webpages containing the designated information in the subscriber data object to the third party via the network 114 (block 1008).

To assist the subscriber in communicating with the third party, the HSA-MP integration server 102 may provide an on-line communication service between the subscriber and the third party (block 1010). The on-line communication service may be, for example, an instant messaging service being displayed simultaneously with the webpage(s) containing the subscriber information. In this manner, both the third party and subscriber are able to view the same information and communicate with each other via the on-line communication service.

Once this session has ended and at a later time, the HSA-MP integration server 102 may receive another request from the third party to access the subscriber information (block 1012). In response to the request, the HSA-MP integration server 102 checks the subscriber data object to determine whether the temporary access for the third party is still valid (block 1014). If the temporary access is not valid, the HSA-MP integration server 102 denies access and sends a notification of such to the third party via the network 114 (block 1016). If, on the other hand, the temporary access for the third party is still valid, the HSA-MP integration server 102 sends the designated information to the third party as per block 1008.

XII. Generating Statistical Analysis and Reports

Since the HSA-MP integration server 102 is capable of integrating HSA-account information and health plan information for many subscribers, the HSA-MP integration server 102 has an abundant amount of useful information. Such information may be analyzed to provide insights into how subscribers use their respective HSA accounts and/or what medical services and/or products are being purchased. The HSA-MP integration server 102 provides a feature of performing statistical analysis and generating reports based on a set of input parameters. Accordingly, the following describes an exemplary method of generating and providing a statistical report concerning information in a plurality of subscriber data objects.

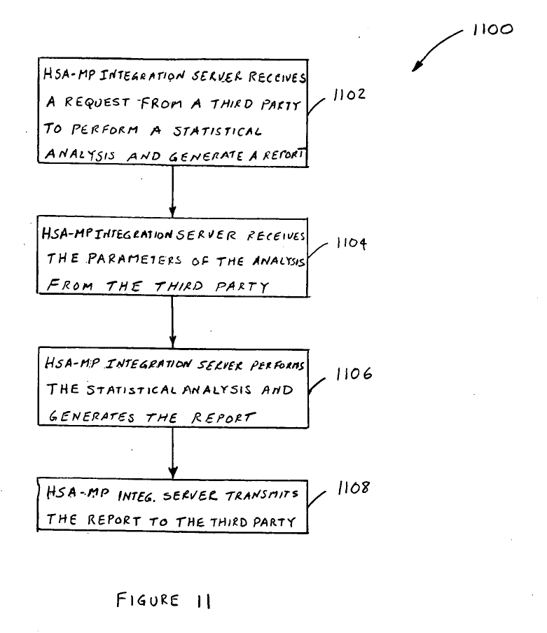

FIG. 11 illustrates a flow diagram of an exemplary method 1100 of generating and providing a statistical report concerning information in a plurality of subscriber data objects in accordance with another embodiment of the invention. According to the method 1100, the HSA-MP integration server 102 receives a request to perform a statistical analysis on information in subscribers' data objects and generate a report therefrom from a third party (e.g., the employer server 118) via the network 114 (block 1102). In this regard, the third party, using a web browser, accesses a webpage generated by the HSA-MP integration server 102 that includes an input object to receive a username/password. The HSA-MP integration server 102 approves the request if the third party enters the appropriate username and password.

After the access request has been approved, the HSA-MP integration server 102 receives the parameters for the statistical analysis from the third party via the network 114 (block 1104). In this regard, the HSA-MP integration server 102 may generate and provide to the third party a webpage including an input object to receive the parameters for the statistical analysis. The HSA-MP integration server 102 may limit the scope of the information to be analyzed based on the third party. For example, if the third party is Employer A, the HSA-MP integration server 102 may limit any statistical analysis to information related to subscriber information related to employees of Employer A.

The parameters will depend on the type of statistical information desired by the third party. For example, input parameters may include subscriber age delimiters, subscriber residence delimiters, subscriber gender delimiters, subscriber health history delimiters, subscriber drug use delimiters, subscriber HSA account balance delimiters, etc. Output parameters may include, for example, number or percent of subscribers that meet the input delimiters, average annual HSA funds used per subscriber, amount of HSA funds per subscriber used to purchase certain types of medical services and/or products, etc.

After receiving the parameters for the statistical analysis, the HSA information server 102 performs the analysis and generates a report therefrom (block 1106). In this regard, the HSA-MP integration server 102 may dynamically generate a webpage that contains the results of the requested statistical analysis report. The HSA-MP integration server 1108 then sends the report to the third party by way of the network 114 (block 1108). This may entail the requesting third party, using a web browser running on a server or other device, accessing the web page containing the results of the statistical analysis report.

XIII. Alternative System Implementations

In the example described above, the HSA-MP integration server 102 was separate from the financial institution server that manages HSA accounts and separate from the health care insurer server that manages health plan accounts. Again, the HSA-MP integration server 102 may be implemented in this manner in situations where the financial institution does not want to have access to subscribers' health plan information because it does not want to meet the HIPPA requirements; and in the situation where the health care insurer does not want to receive subscribers' HSA account information for any of a number of reasons. In such scenario, the HSA-MP integration server 102 will typically be hosted by a third party and include data security features, such as firewalls, to prevent unauthorized access of the data.

However, the HSA-MP integration software module need not be implemented as described above. It shall be understood that the HSA-MP integration software module may be implemented in numerous other ways. For example, the HSA-MP integration software module may be integrated within the financial institution local network, and/or within the health care insurer local network. Additionally, the HSA-MP integration software module need not get health plan information solely from a health care insurer server, but may be able to obtain health plan information from other sources such as from dental insurers, long term care insurers, and third party administrators (TPAs). The following describes various exemplary communication system environments in which the HSA-MP integration software module may be implemented.

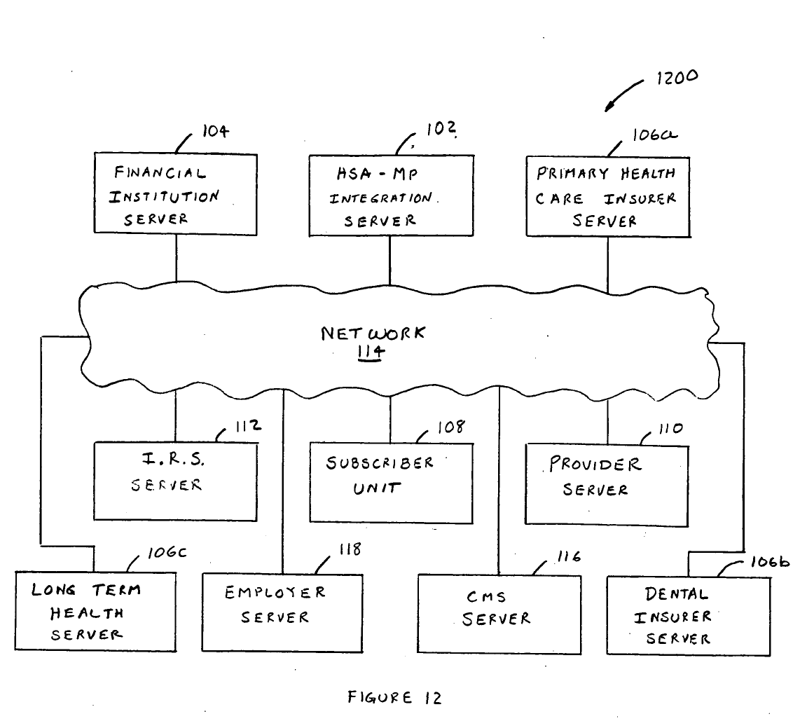

FIG. 12 illustrates a block diagram of another exemplary communication system 1200 in accordance with another embodiment of the invention. In many cases, a subscriber may receive coverage from multiple health insurers. For example, the subscriber may have a primary health care insurer, a dental care insurer, and a long term health insurer. The HSA-MP integration server 102 need not be limited to interfacing with a single insurer of a subscriber, but may interface with multiple insurers of the subscriber. Accordingly, the communication system 1200 is the same as that of communication system 100 previously discussed except that the health care insurer server 106 is replaced with a primary health care insurer server 106a, a dental health care insurer server 106b, and a long term care health insurer server 106c, all providing separate coverage for a subscriber. The HSA-MP integration server 102 interfaces with each of these servers 106a, 106b, and 106c in the same way it interfaces with server 106 described above. In this case, the subscriber data object would include health plan information pertaining to the primary, dental, and long term care health insurers.

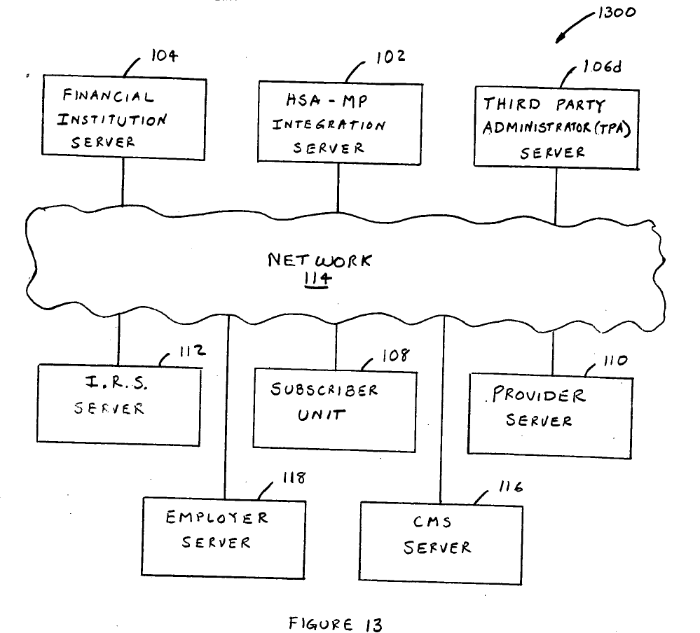

FIG. 13 illustrates a block diagram of another exemplary communication system 1300 in accordance with another embodiment of the invention. In many cases, an employer of the subscriber acts as the effective insurer in paying the subscriber medical expenses that exceed a deductible. Typically such an employer uses a third party administrator (TPA) to perform all the medical claim administration. In this scenario, the HSA-MP integration server 102 interfaces with the TPA in the same manner that it interfaces with the health care insurer. Accordingly, the communication system 1300 is the same as that of communication system 100 previously discussed except that the health care insurer server 106 is replaced with a TPA server 106d.

Also in this scenario, the employer typically uses benefit administration software to keep track of employee benefit information. Examples of such benefit administration software include ADP, Employease, RewardsPlus, and Spectrum. Typically, such software programs can generate a file that provides information on selected employees. If an employer wants the TPA to administer health claims for all or some of its employees, the employer sends the file to the TPA so that it can obtain the information of employees whose medical claims are to be administered. The HSA-MP integration server 102 may be able to receive such file to create subscriber data objects for the employees identified in that file. In other words, the HSA-MP integration server 102 may be able to read output files of such benefit administration software to in essence download a batch of new subscribers. The HSA-MP integration server 102 will typically receive this file from the TPA server 106d, but it may also receive it from the employer server 118.

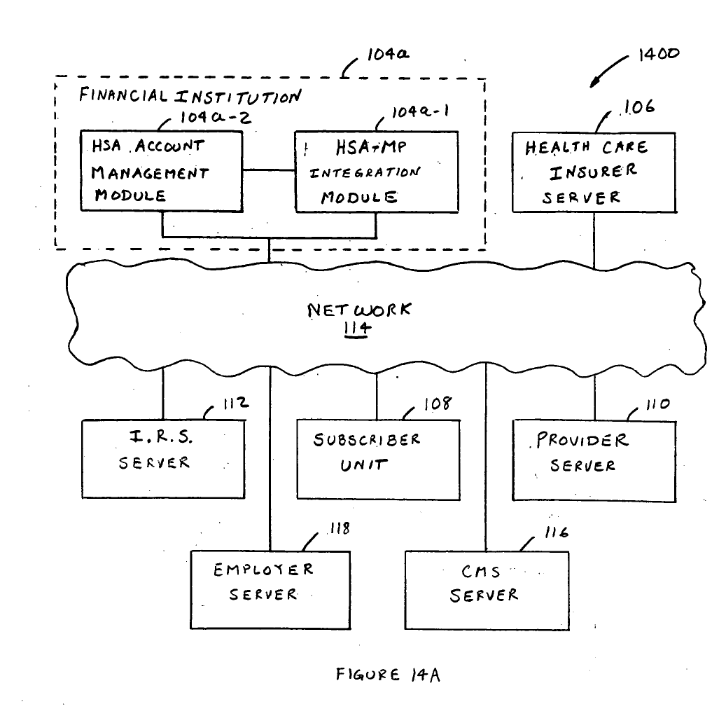

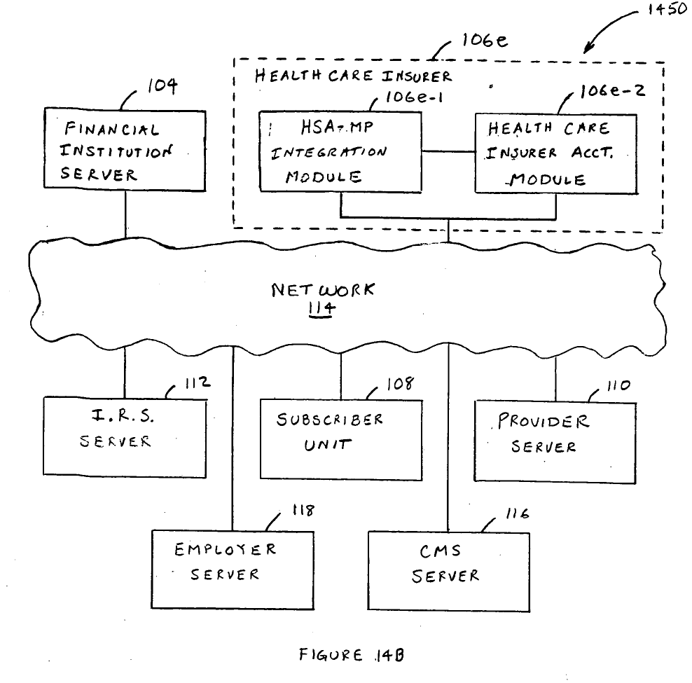

FIG. 14A illustrates a block diagram of another exemplary communication system 1400 in accordance with another embodiment of the invention. The HSA-MP integration server 102 need not be situated apart from the financial institution server 104, but may reside in the local network of the financial institution server. Accordingly, the communication system 1400 is the same as that of communication system 100 except that the HSA-MP integration software module resides within the financial institution local network 104a. Therefore, the financial institution local network 104a includes an HSA-MP integration software module 104a-1 and an HSA account management module 104a-2. Again, the modules 104a-1 and 104a-2 may be on different servers in which case they communicate with each other by way of a network or hardware interface, or may be on the same server in which case they communicate by way of a software interface.

FIG. 14B illustrates a block diagram of another exemplary communication system 1450 in accordance with another embodiment of the invention. The HSA-MP integration server 102 need not be situated apart from the health care insurer server 106, but may reside in the local network of the health care insurer. Accordingly, the communication system 1450 is the same as that of communication system 100 except that the HSA-MP integration software module resides within the health care insurer local network 106e. Therefore, the health care insurer local network 106e includes an HSA-MP integration software module 106e-1 and a health care insurer account management module 106e-2. Again, the modules 106e-1 and 106e-2 may be on different servers in which case they communicate with each other by way of a network or hardware interface, or may be on the same server in which case they communicate by way of a software interface.

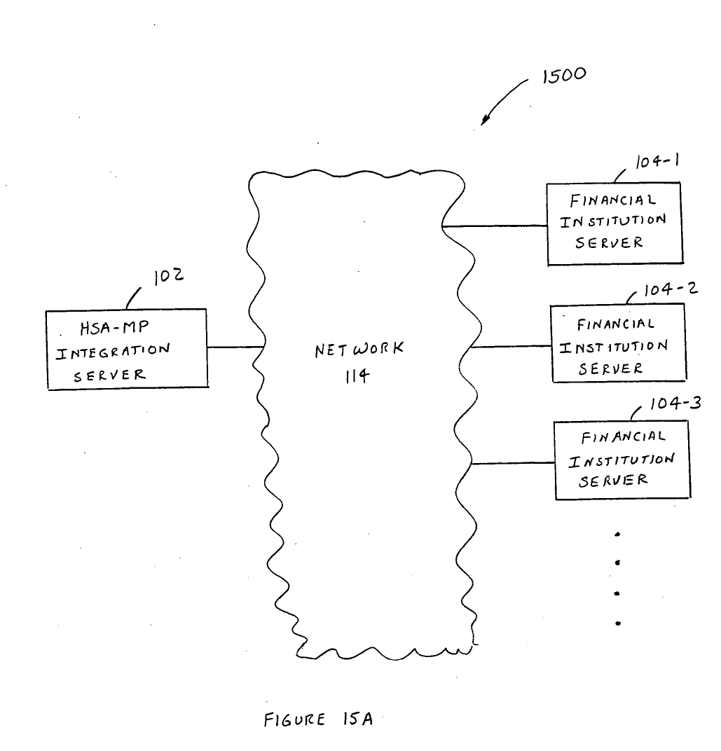

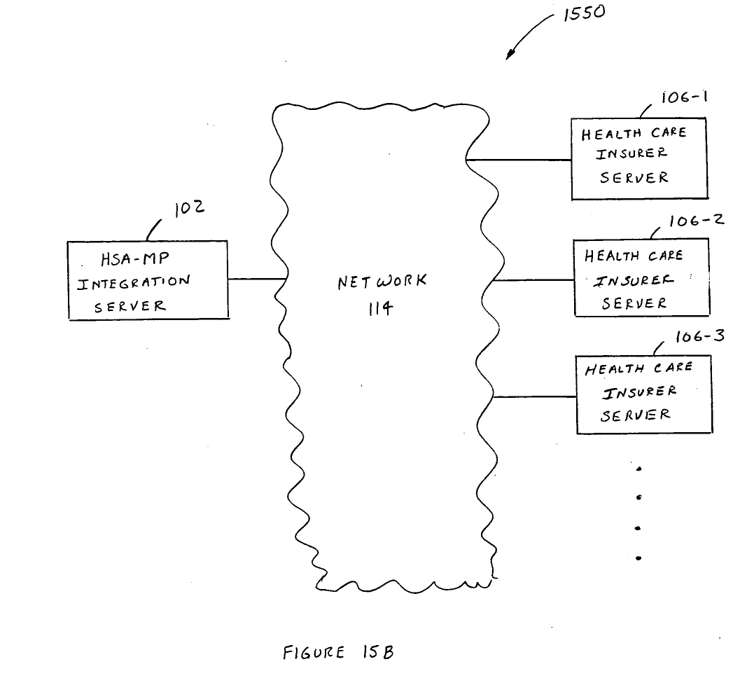

FIG. 15A illustrates a block diagram of another exemplary communication system 1500 in accordance with another embodiment of the invention. As discussed above, the HSA-MP integration server 102 need not communicate with only a single financial institution server, but may communicate with many financial institution servers containing and providing information related to HSA accounts of many subscribers. Accordingly, the communication system 1500 comprises a plurality of financial institution servers 104-1, 104-2, 104-3, etc., coupled to the HSA-MP integration server 102 via the network 114. In this manner, the HSA-MP integration server 102 serves as a single depository of HSA account information received from a plurality of different financial institutions.

FIG. 15B illustrates a block diagram of another exemplary communication system 1550 in accordance with another embodiment of the invention. As discussed above, the HSA-MP integration server 102 need not communicate with only a single health care insurer server, but may communicate with many health care insurer servers containing and providing information related to health plans of many subscribers. Accordingly, the communication system 1550 comprises a plurality of health care insurer servers 106-1, 106-2, 106-3, etc., coupled to the HSA-MP integration server 102 via the network 114. In this manner, the HSA-MP integration server 102 serves as a single depository of health plan information received from a plurality of different health care insurers.

IX. Internal HSA-MP Information Server Structure and Software Modules

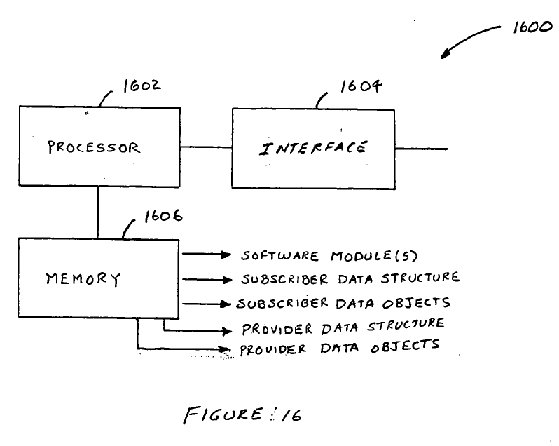

FIG. 16 illustrates a block diagram of an exemplary HSA-MP integration server 1600 in accordance with another embodiment of the invention. The HSA-MP integration server 1600 comprises a processor 1602, an interface 1604, and a memory 1606. The processor 1602 performs the various operations of the HSA-MP integration server as described above. The interface 1604, which may be a network, hardware or software interface, serves to send and receive information to and from various devices and/or modules. The memory 1606, which serves generally as a computer readable medium, stores software module(s) that control the processor 1602 in performing its various operations, subscriber data structure, subscriber data objects, provider data structure, provider data objects, and possibly other information.

X. Exemplary Webpages Generated by the HSA-MP Integration Module

The following describes various examples of webpages generated by the HSA-MP integration software module:

FIG. 17 illustrates a screen shot of an exemplary Home webpage 1700 generated by the HSA-MP integration server in accordance with another embodiment of the invention. The Home webpage 1700 may be accessed after the subscriber has entered a username and password in an access webpage (not shown). The Home webpage 1700 includes a title section 1702, a navigation section 1704, and a navigation summary section 1706. The title section 1702 may be titled in any number of ways, such as “Welcome to ABC Health Plan”, the name of the subscriber's health care insurer. The navigation section 1704 provides a plurality of hyperlinks that allows the subscriber to navigate through various primary webpages generated by the HSA-MP integration server. In this example, the navigation section 1704 includes hyperlinks to the following webpages: Member Info, My Benefits, Healthcare Claims, HSA Activity, Summary, Correspondence, and Help & FAQ.

The navigation summary section 1706 basically summarizes the information provided in the primary webpages generated by the HSA-MP integration server, except for the Home webpage. In the navigation summary section 1706 adjacent to the Home Page hyperlink, the subscriber's name, HSA account balance, health plan deductible, and remaining amount to meet the deductible are provided. In the navigation summary section 1706 adjacent to the Member Info hyperlink, a summary of the Member Info webpage is provided, such as displaying subscriber personal information, allowing a subscriber to change his/her password, allowing a subscriber to enroll in an HSA account, and providing customer service information to the subscriber. In the navigation summary section 1706 adjacent to the My Benefits hyperlink, a summary of the My Benefits webpage is provided, such as displaying a summary of the subscriber's health plan benefits.

In the navigation summary section 1706 adjacent to the Healthcare Claims hyperlink, a summary of the Healthcare Claims webpage is provided, such as displaying subscriber health care claims. In the navigation summary section 1706 adjacent to the HSA Activity hyperlink, a summary of the HSA Activity webpage is provided, such as providing HSA financial transaction information. In the navigation summary section 1706 adjacent to the Summary hyperlink, a summary of the Summary webpage is provided, such as summarizing the health plan and HSA account information and comparing HSA account expenditures with the health plan deductible. In the navigation summary section 1706 adjacent to the Correspondence hyperlink, a summary of the Correspondence webpage is provided, such as allowing the subscriber to communicate with the financial institution and health care insurer via email. In the navigation summary section 1706 adjacent to the Help & FAQ hyperlink, a summary of the Help & FAQ webpage is provided, such as displaying answers to frequently asked questions and other helpful information.

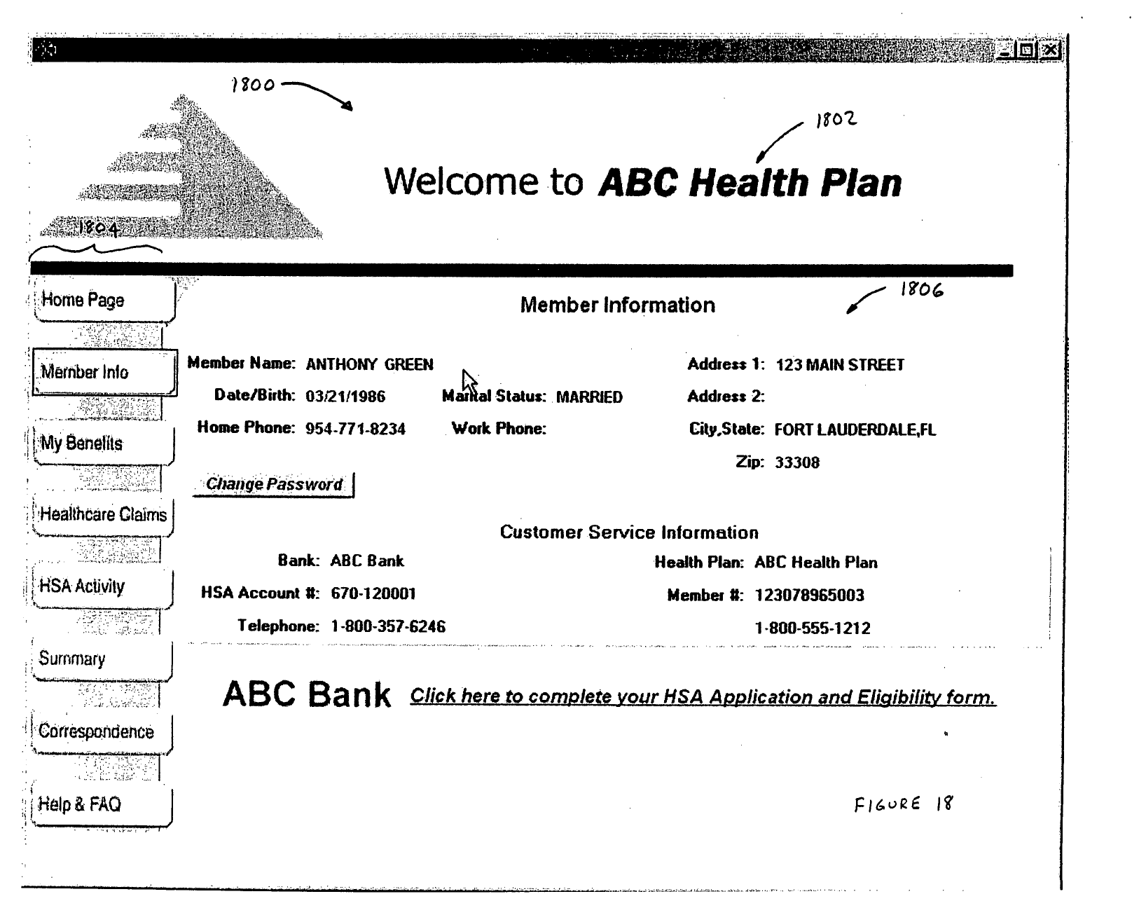

FIG. 18 illustrates a screen shot of an exemplary Member Info webpage 1800 generated by the HSA-MP integration server in accordance with another embodiment of the invention. The Member Info webpage 1800 includes a title section 1802, a navigation section 1804, and a member information section 1806. The title section 1802 may be the same as the title section 1702 of the Home webpage 1700. The navigation section 1804 may be the same as the navigation section 1704 of the Home webpage 1700. The member information section displays the subscriber's personal information (e.g., name, date of birth, social security number, marital status, and address), the subscriber's HSA account information (e.g., name and telephone of financial institution, and HSA account number), and the subscriber's health plan information (name and telephone number of health care insurer, and health plan member number). The member information section 1806 further includes a hyperlink “Change Password” for allowing a subscriber to change his/her password, and a hyperlink for allowing a subscriber to complete an HSA account enrollment form.

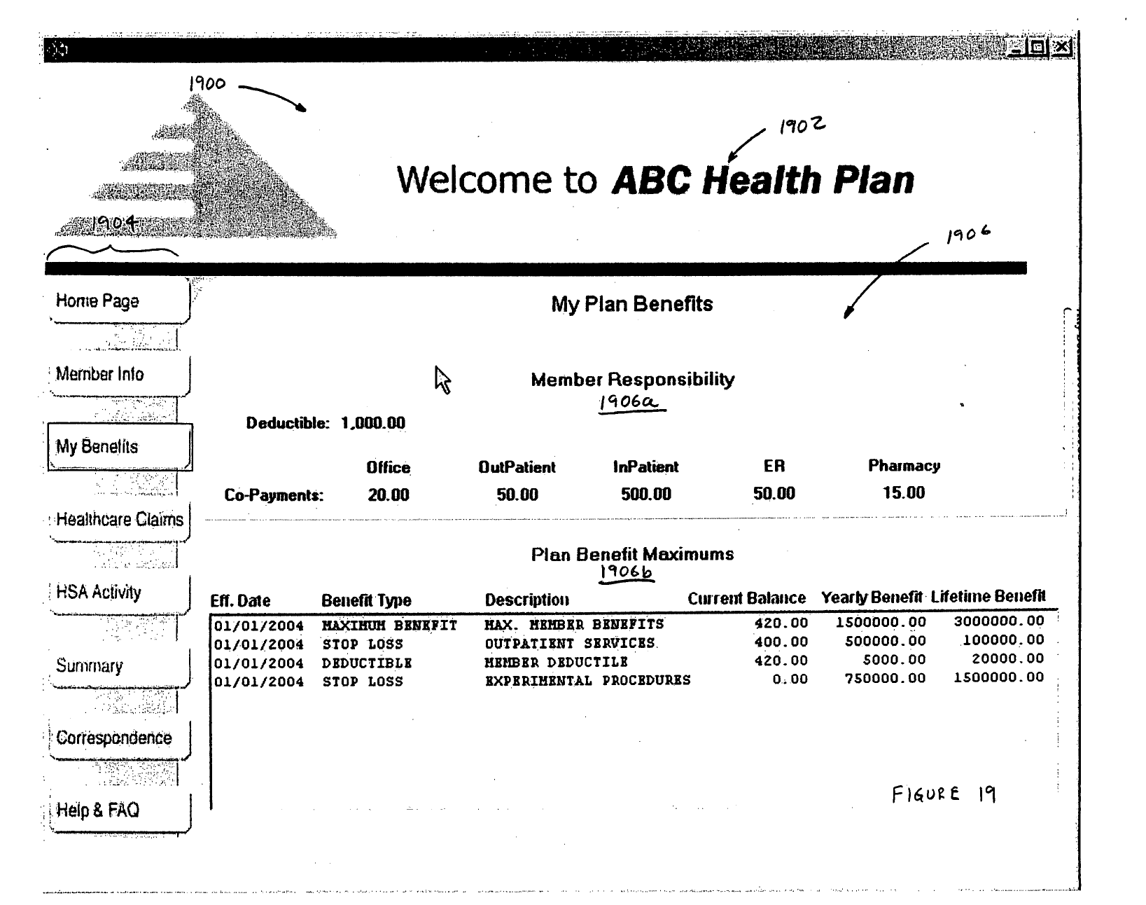

FIG. 19 illustrates a screen shot of an exemplary My Plan Benefits webpage 1900 generated by the HSA-MP integration server in accordance with another embodiment of the invention. The My Plan Benefits webpage 1900 includes a title section 1902, a navigation section 1904, and a subscriber health plan benefits information section 1906. The title section 1902 may be the same as the title section 1702 of the Home webpage 1700. The navigation section 1904 may be the same as the navigation section 1704 of the Home webpage 1700. The subscriber health plan benefits information section 1906 includes a sub-section 1906a that provides information concerning the subscriber's financial responsibility, such as the deductible and the co-payments related to office visits, OutPatient care, InPatient care, Emergency Room (ER) visits, and the purchase of prescription drugs at a pharmacy. The subscriber health plan benefits information section 1906 includes another sub-section 1906b that provides information related to the subscriber health plan benefit maximums (e.g., maximum yearly and lifetime benefits, stop loss, yearly deductible) and the current balance of these maximums. As discussed above, this information is received from the health care insurer server(s).

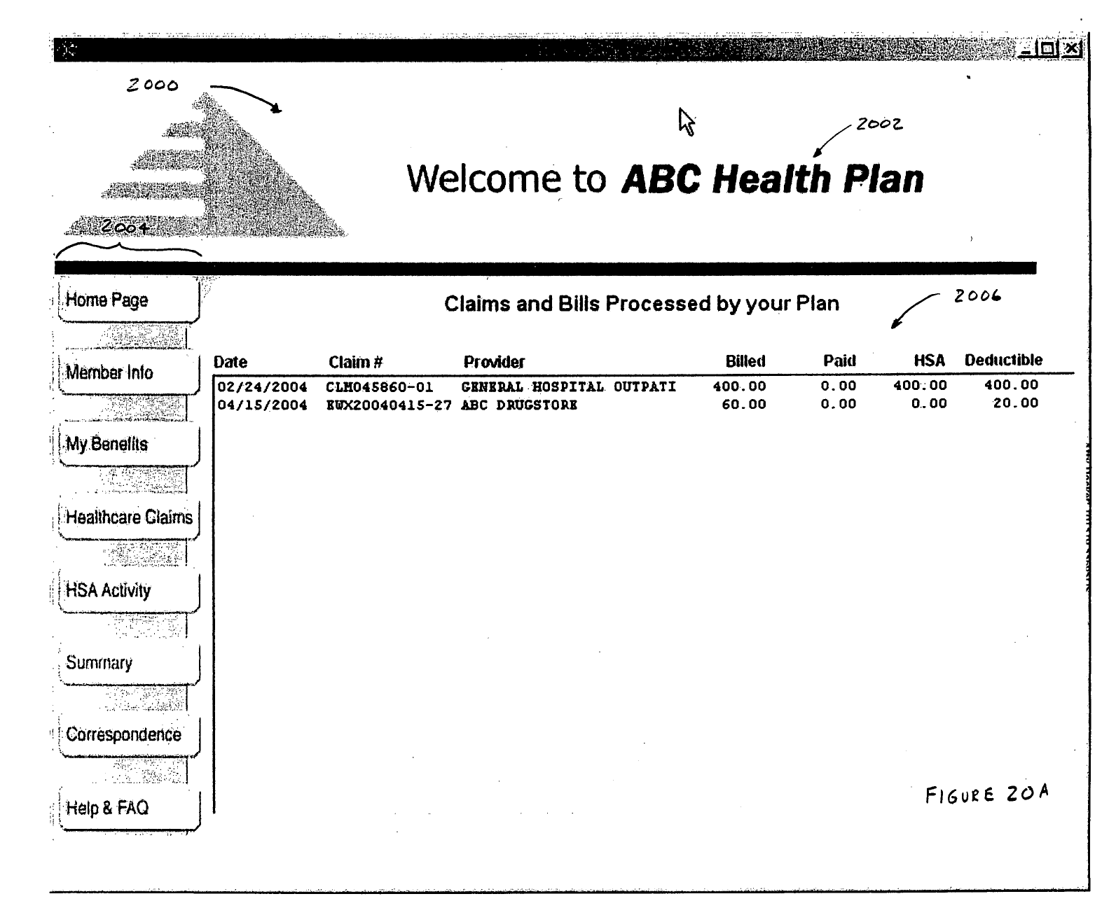

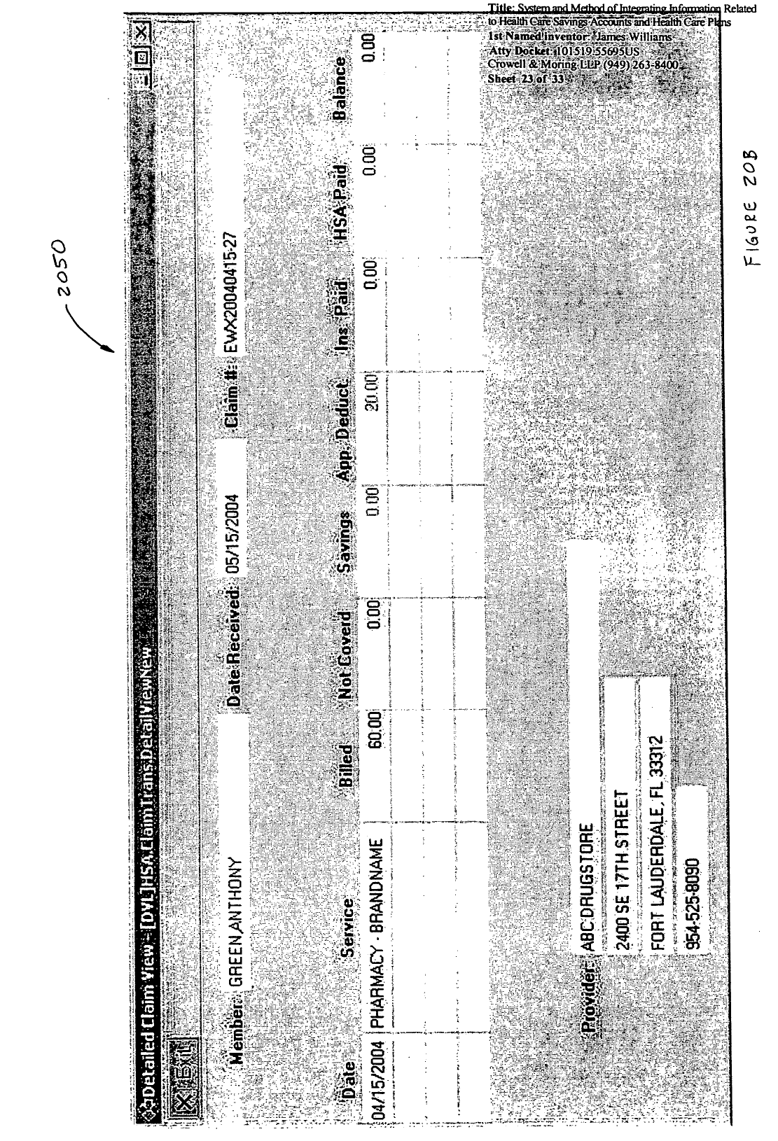

FIG. 20A illustrates a screen shot of an exemplary Healthcare Claims webpage 2000 generated by the HSA-MP integration server in accordance with another embodiment of the invention. The Healthcare Claims Benefits webpage 2000 includes a title section 2002, a navigation section 2004, and a subscriber claims and bills processed section 2006. The title section 2002 may be the same as the title section 1702 of the Home webpage 1700. The navigation section 2004 may be the same as the navigation section 1704 of the Home webpage 1700. The subscriber claims and bills processed section 2006 includes information related to the subscriber's health care claims (e.g., date of claim, claim number, name of provider, amount billed, amount paid by the subscriber's health care insurer, amount paid out of the subscriber's HSA account, and amount of the bill that counts towards the deductible). As discussed above, this information is received from the health care insurer server(s).

FIG. 20B illustrates a screen shot of an exemplary Healthcare Claims sub-webpage 2050 generated by the HSA-MP integration server in accordance with another embodiment of the invention. In the Healthcare Claims webpage 2000, a subscriber may click on one of the claim entries to ascertain more detailed information about the claim. In this example, the subscriber clicked on the second entry to ascertain more information about the purchase at ABC Drugstore. In response, the HSA-MP integration server provides the sub-webpage 2050 to the subscriber, which provides further details about the purchase including the address and telephone number of the provider, and the particular service/product purchased and associated provider discount, e.g., a “pharmacy-brand name” drug from the ABC Drugstore and $0.00 Savings (provider discount)).

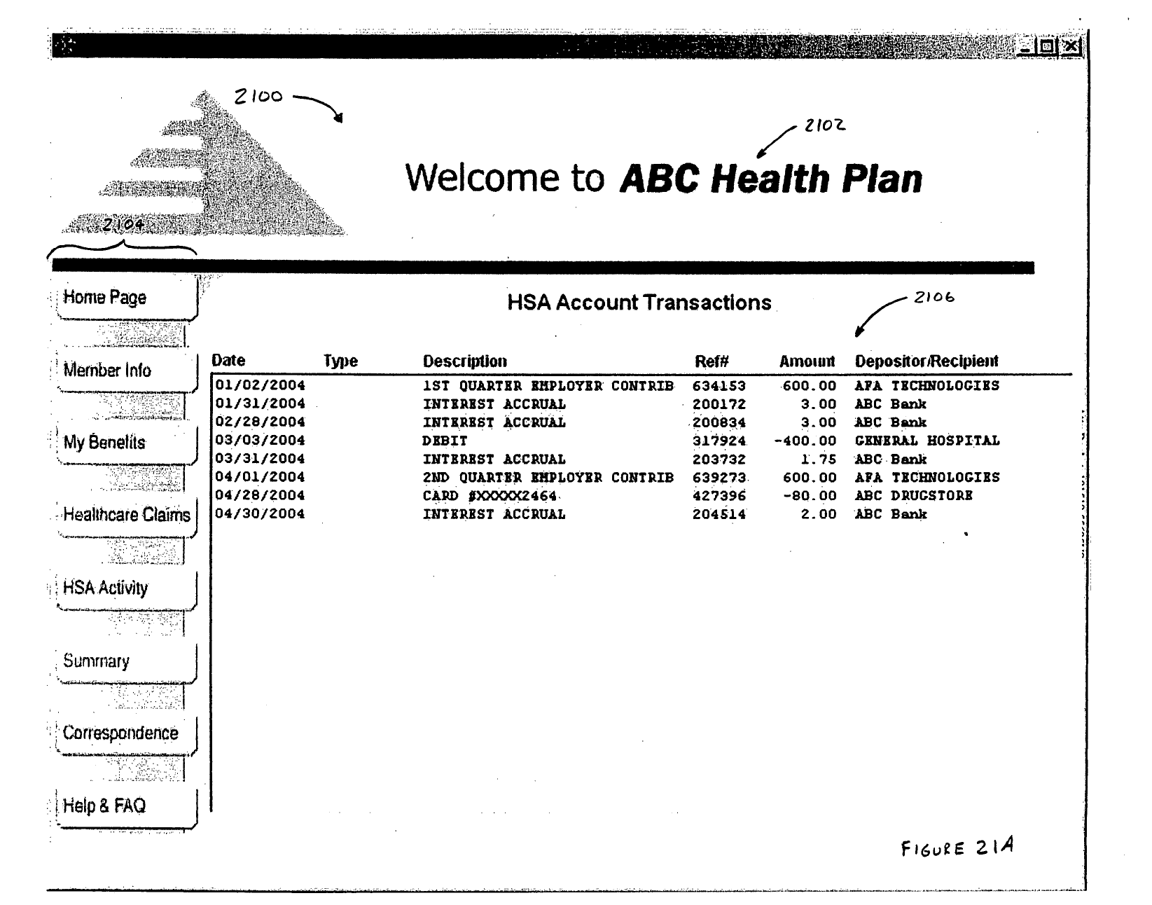

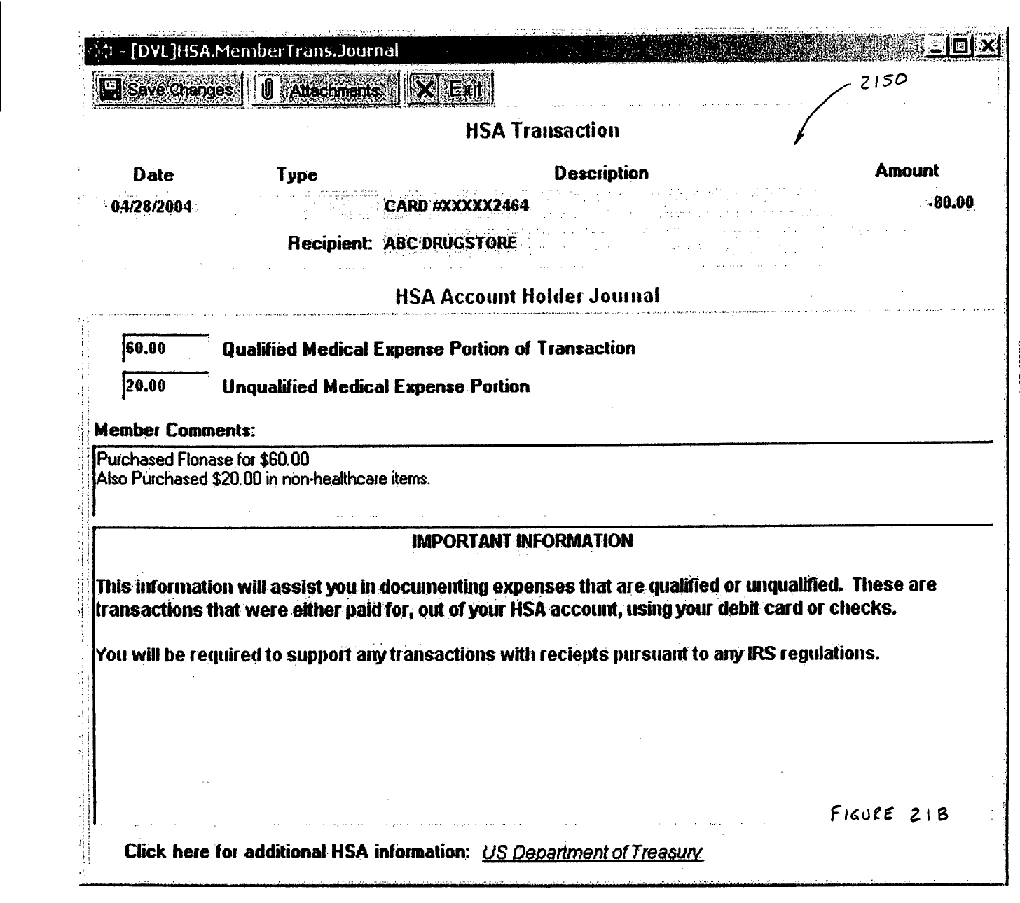

FIG. 21A illustrates a screen shot of an exemplary HSA Activity webpage 2100 generated by the HSA-MP integration server in accordance with another embodiment of the invention. The HSA Activity webpage 2100 includes a title section 2102, a navigation section 2104, and an HSA account transaction section 2106. The title section 2102 may be the same as the title section 1702 of the Home webpage 1700. The navigation section 2104 may be the same as the navigation section 1704 of the Home webpage 1700. The HSA account transaction section 2106 includes information related to the subscriber's HSA account transactions (e.g., date of transaction, type of transaction (e.g., contribution, interest, withdrawal, etc.), description of the transaction, transaction reference number, transaction amount, and depositor/recipient). This information is received from the financial institution managing the HSA account.

FIG. 21B illustrates a screen shot of an exemplary HSA Activity sub-webpage 2150 generated by the HSA-MP integration server in accordance with another embodiment of the invention. In the HSA Activity webpage 2100, a subscriber may click on one of the transaction entries to ascertain more detailed information about the transaction. In this example, the subscriber clicked on the second-to-last entry to ascertain more information about the credit card transaction at ABC Drugstore. In response, the HSA-MP integration server provides the sub-webpage 2150 to the subscriber, which provides further details about the transaction.

The HSA Activity sub-webpage 2150 includes an input object having a first field to receive information regarding the amount of the transaction that went towards a qualified medical expense (e.g., $60.00), a second field to receive information regarding the amount of the transaction that went towards an unqualified medical expense (e.g., $20.00), and a third field to receive comments from the subscriber about the transaction. This allows a subscriber to annotate the transaction for any purpose, such as for tax purchases. The HSA-MP integration server would store any information received from the subscriber in the subscriber data object. It shall be understood that the qualified medical expense portion and unqualified medical expense portion information need not be entered by the subscriber, but may be obtained from the health care insurer server or a database containing historical information related to the qualification status of previously-purchased medical services and/or products. The HSA Activity sub-webpage 2150 may further include an information section concerning taxes and a hyperlink to the US Department of Treasury webpage to obtain more HSA information.

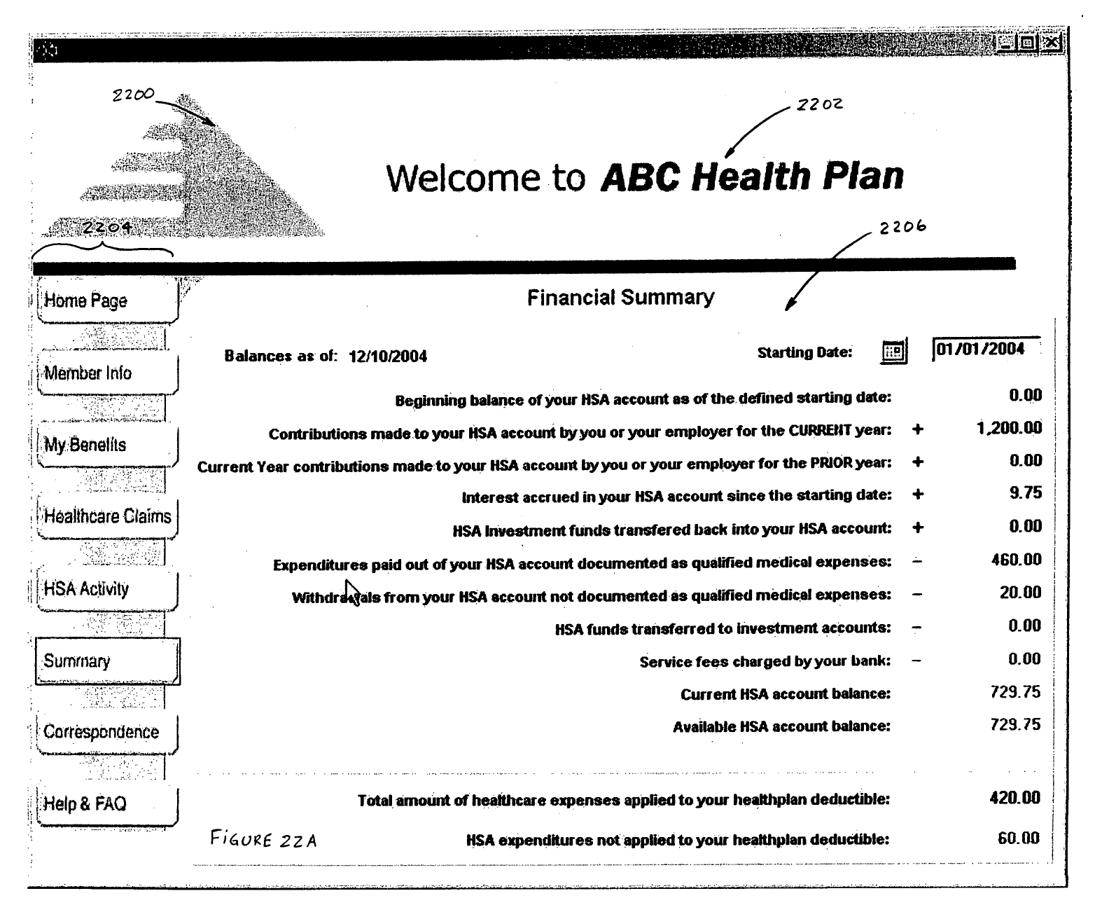

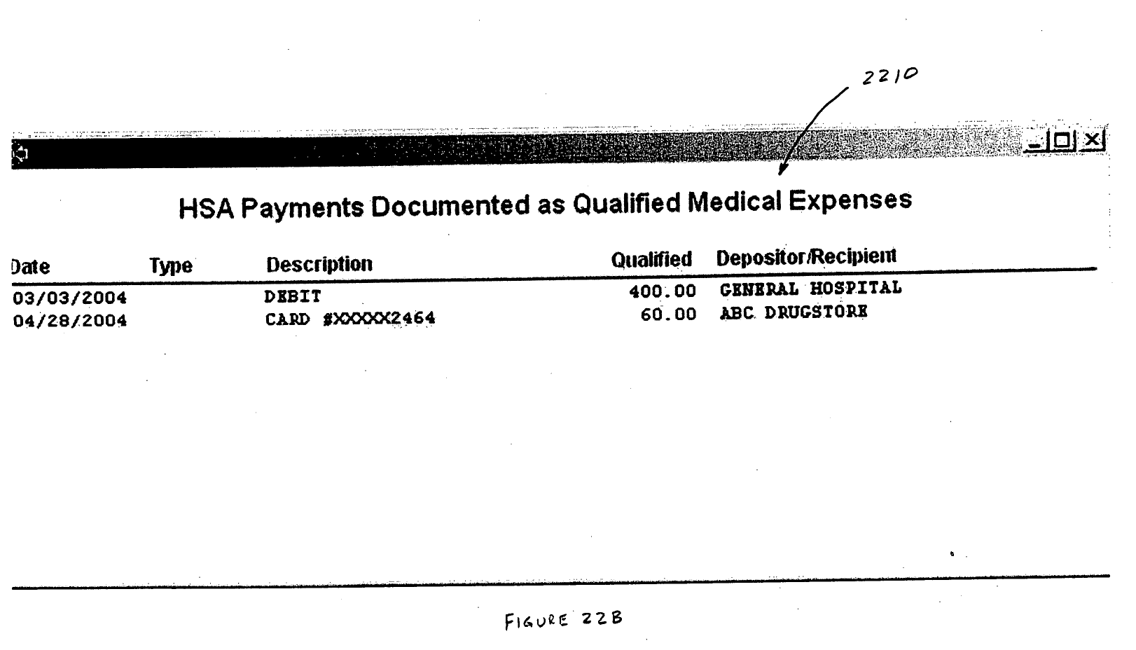

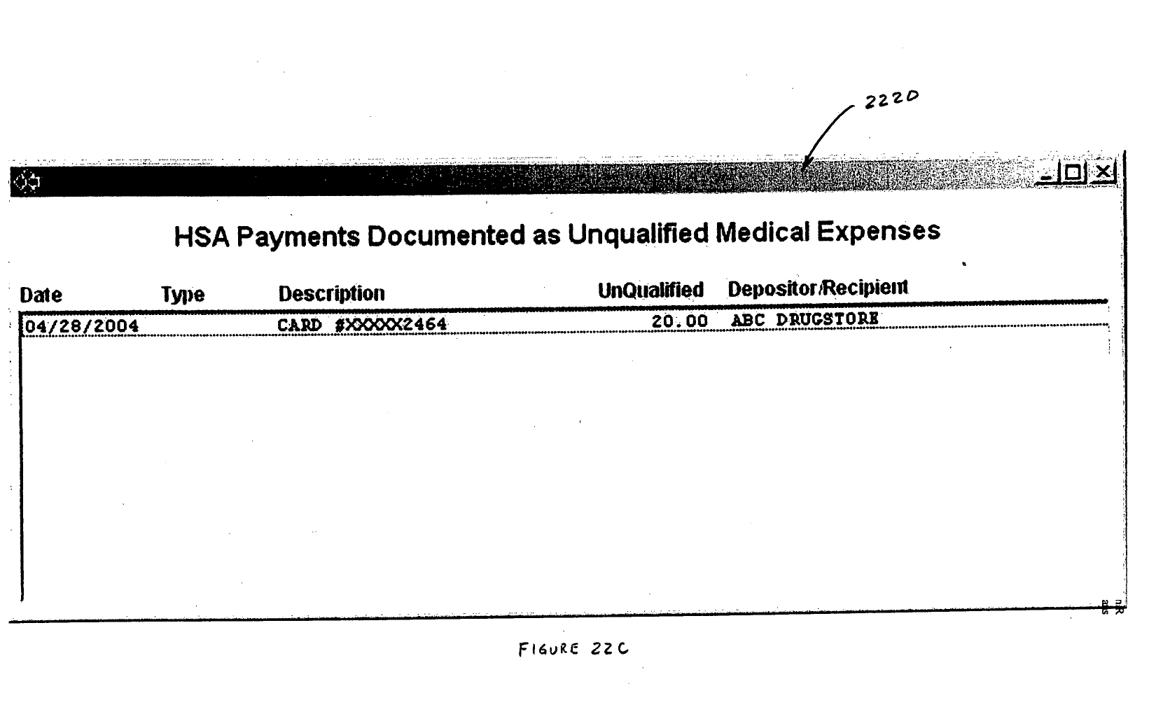

FIG. 22A illustrates a screen shot of an exemplary Summary webpage 2200 generated by the HSA-MP integration server in accordance with another embodiment of the invention. The Summary webpage 2200 includes a title section 2202, a navigation section 2204, and a financial summary section 2206. The title section 2202 may be the same as the title section 1702 of the Home webpage 1700. The navigation section 2204 may be the same as the navigation section 1704 of the Home webpage 1700. The financial summary section 2206 includes a summary of certain information related to the subscriber's HSA account. The HSA-MP information software module derives some or all of this information from the HSA account and health care plan information it has received. The financial summary section 2106 also includes an input object having a field to receive a starting date that the HSA-MP integration server uses to calculate the information provided in this section.

Such information is important to a subscriber for efficiently managing his/her HSA account, and includes the subscriber's HSA account balance as of the specified starting date (e.g., $0.00), contributions made to the HSA account for the current year (e.g., $1200), contributions made to the HSA account for the prior year (e.g., $0.00), interest accrued in the HSA account since the starting date (e.g., $9.75), HSA funds transferred back from an investment account (e.g., $0.00), withdrawals from the HSA account that went towards qualified medical expenses (e.g., $460.00), withdrawals from the HSA account that went towards unqualified expenses (e.g., $20.00), HSA funds transferred to investment accounts (e.g., 0.00), service fees charged by the financial institution (e.g., $0.00), current HSA account balance (e.g., 729.75), available HSA account balance (e.g., $729.75), HSA account expenditures that went towards the deductible (e.g., 420.00), and HSA account expenditures that was not applied towards the deductible (e.g., $60.00). As discussed above, the HSA-MP information software module derives some or all of this information from the HSA account and health care plan information it has received.

FIG. 22B illustrates a screen shot of an exemplary Summary sub-webpage 2210 generated by the HSA-MP integration server in accordance with another embodiment of the invention. In the Summary webpage 2200, a subscriber may click on one of the summary entries to ascertain more detailed information about the entry. In this example, the subscriber clicked on the sixth entry to ascertain more information about qualified medical expenditures. In response, the HSA-MP integration server provides the sub-webpage 2210 to the subscriber, which provides further details about such expenditures. In this example, $460.00 went towards qualified medical expenditures, of which $400.00 went to General Hospital and $60.00 went to ABC Drugstore. This example relates to the qualified and unqualified expenses documented by the subscriber in the webpage shown in FIG. 21B.

FIG. 22C illustrates a screen shot of another exemplary Summary sub-webpage 2220 generated by the HSA-MP integration server in accordance with another embodiment of the invention. In this example, the subscriber clicked on the seventh entry to ascertain more information about unqualified expenditures. In response, the HSA-MP integration server provides the sub-webpage 2220 to the subscriber, which provides further details about such expenditures. In this example, $20.00 went towards unqualified expenditures to ABC Drugstore, as was also displayed in FIG. 21B.

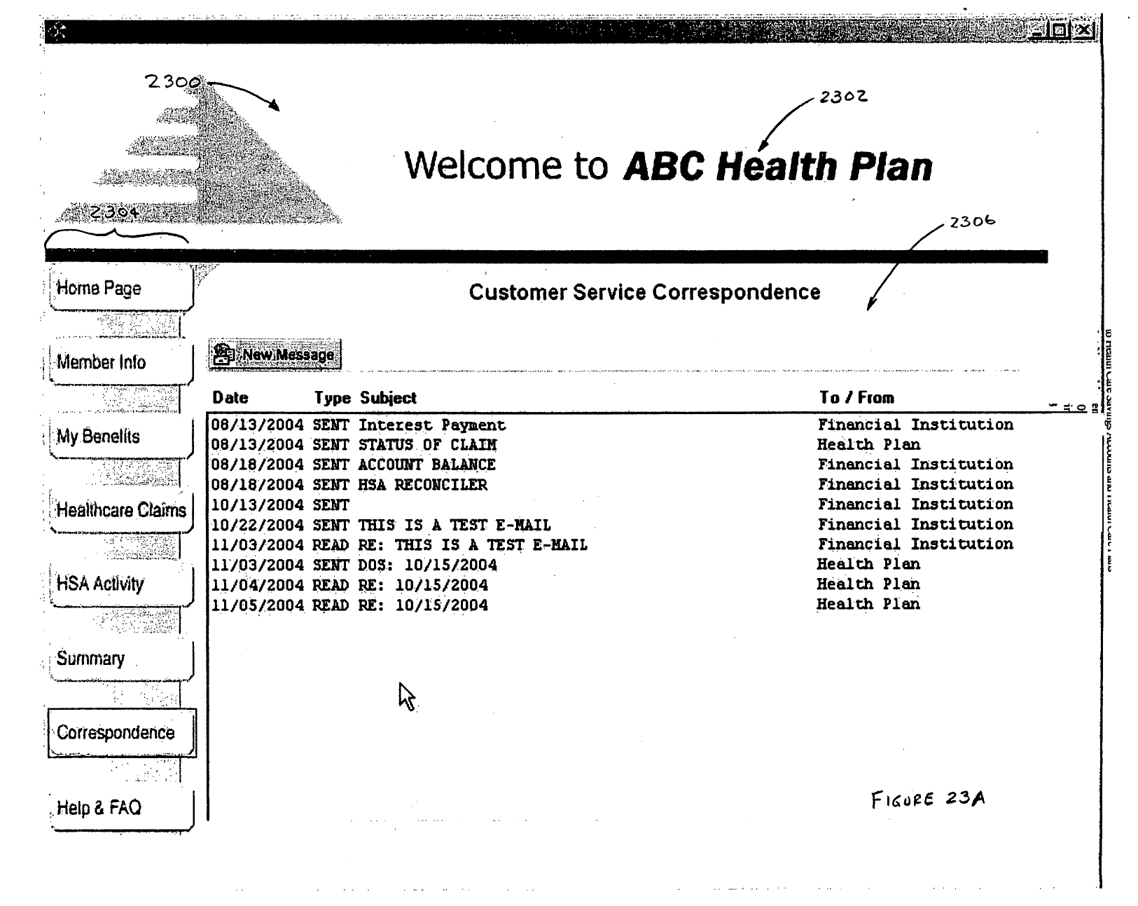

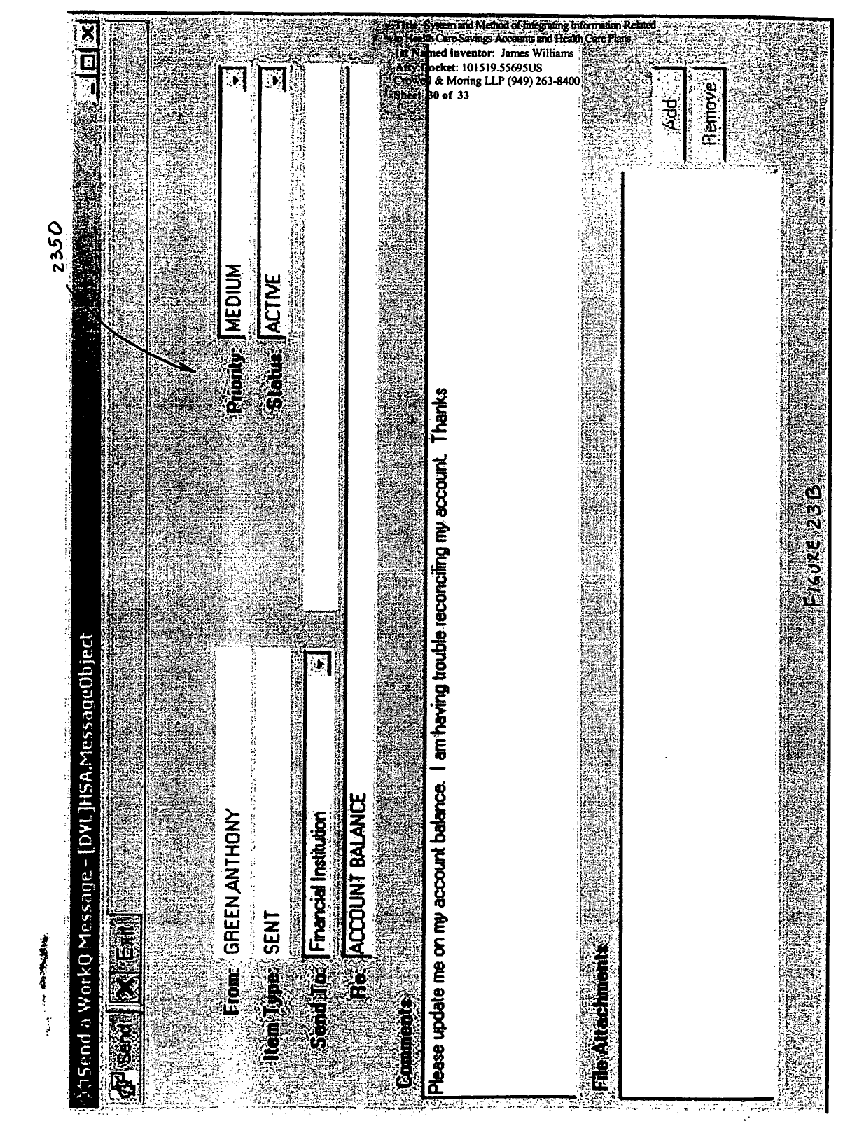

FIG. 23A illustrates a screen shot of an exemplary Correspondence webpage 2300 generated by the HSA-MP integration server in accordance with another embodiment of the invention. The Correspondence webpage 2300 includes a title section 2302, a navigation section 2304, and a customer service correspondence section 2306. The title section 2302 may be the same as the title section 1702 of the Home webpage 1700. The navigation section 2304 may be the same as the navigation section 1704 of the Home webpage 1700. The customer service correspondence section 2306 includes a New Message hyperlink to allow a subscriber to write and send emails to his/her financial institution and health care insurer provider, and a field that provides information regarding emails sent and received by the subscriber. For example, a subscriber may send an email to the financial institution and/or health plan insurer to authorize the payment of a medical claim with funds from his/her HSA account.

FIG. 23B illustrates a screen shot of an exemplary Correspondence sub-webpage 2350 generated by the HSA-MP integration server in accordance with another embodiment of the invention. In the Correspondence webpage 2300, a subscriber may click on one of the email entries to ascertain more detailed information about the email. In this example, the subscriber clicked on the third email entry to ascertain more information about the email sent to the financial institution regarding his/her account balance. In response, the HSA-MP integration server provides the sub-webpage 2350 to the subscriber, which provides further details about the email.

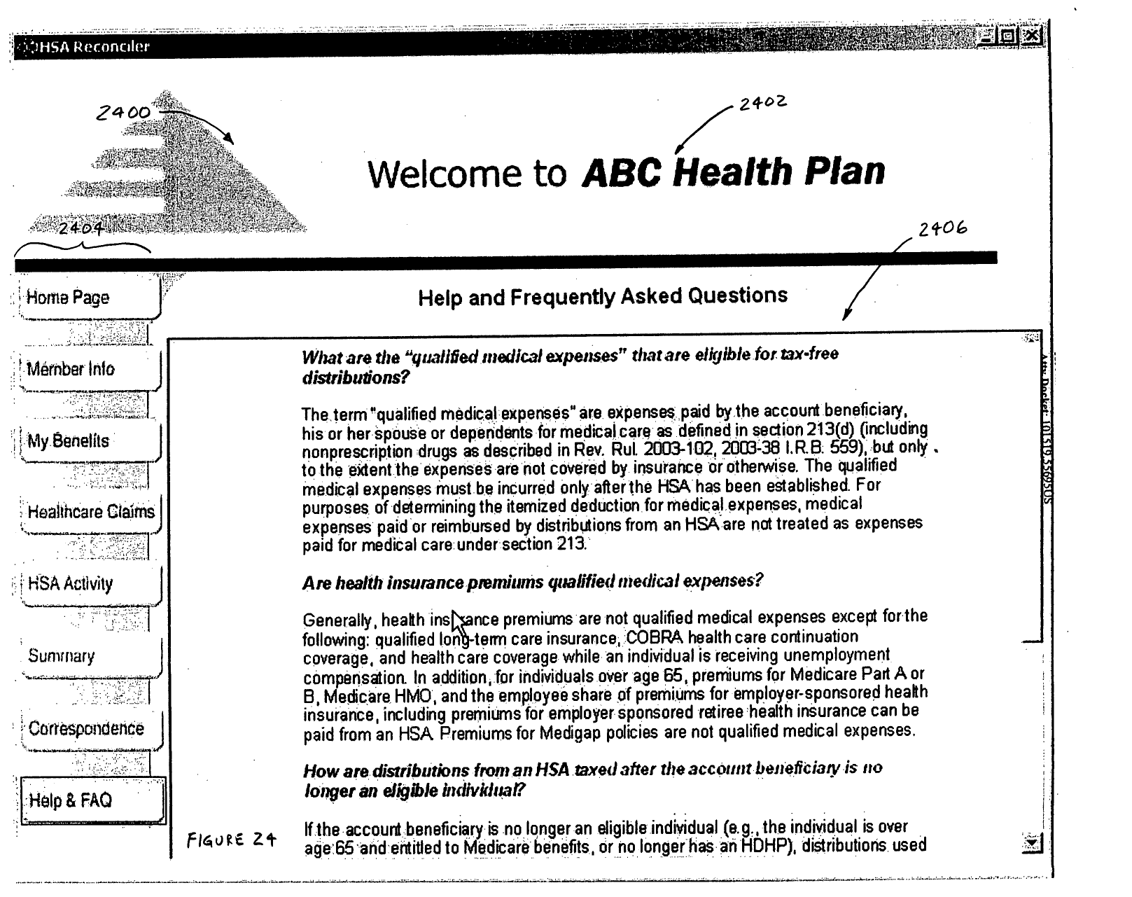

FIG. 24 illustrates a screen shot of an exemplary Help & FAQ webpage 2400 generated by the HSA-MP integration server in accordance with another embodiment of the invention. The Help & FAQ webpage 2400 includes a title section 2402, a navigation section 2404, and a help and frequently asked questions section 2406. The title section 2402 may be the same as the title section 1702 of the Home webpage 1700. The navigation section 2404 may the same as the navigation section 1704 of the Home webpage 1700. The help and frequently asked questions section 2306 includes answers to frequently asked questions and other helpful information for the subscriber.

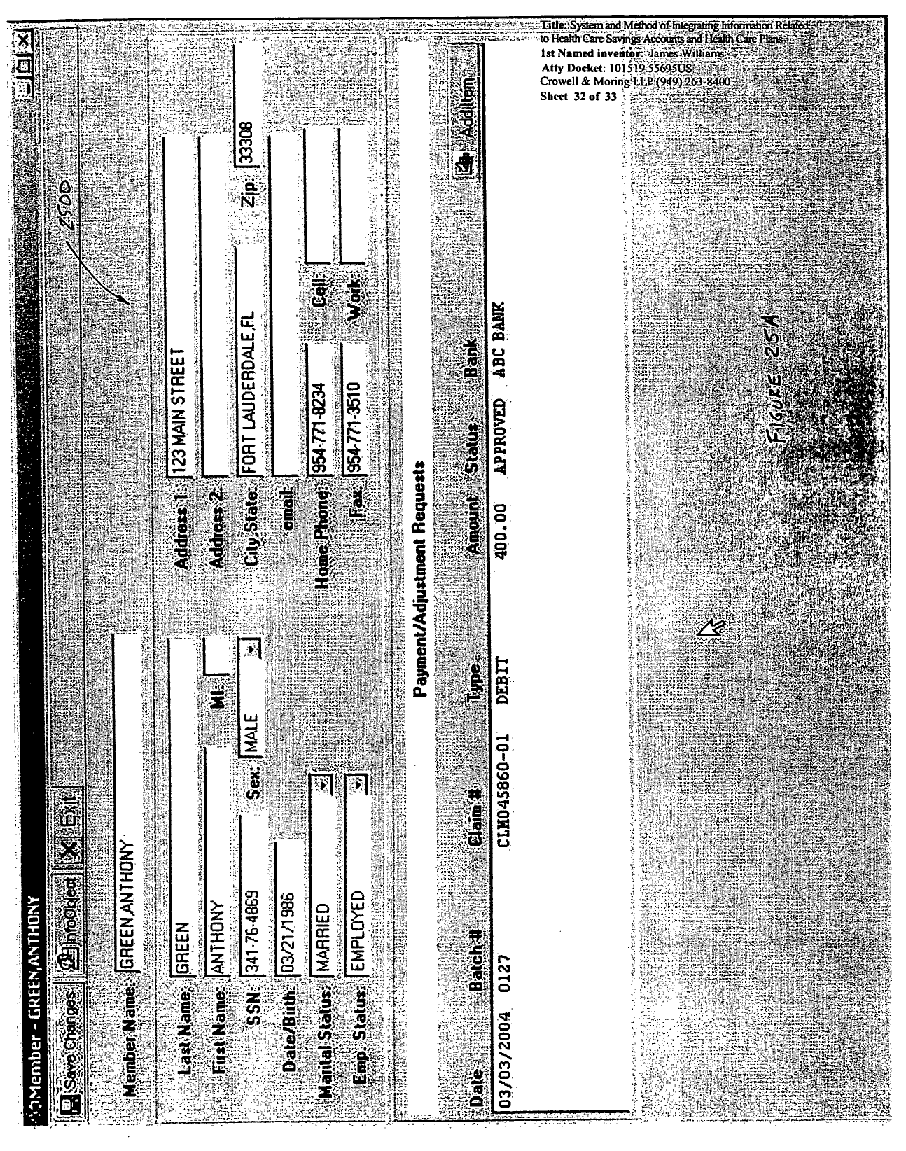

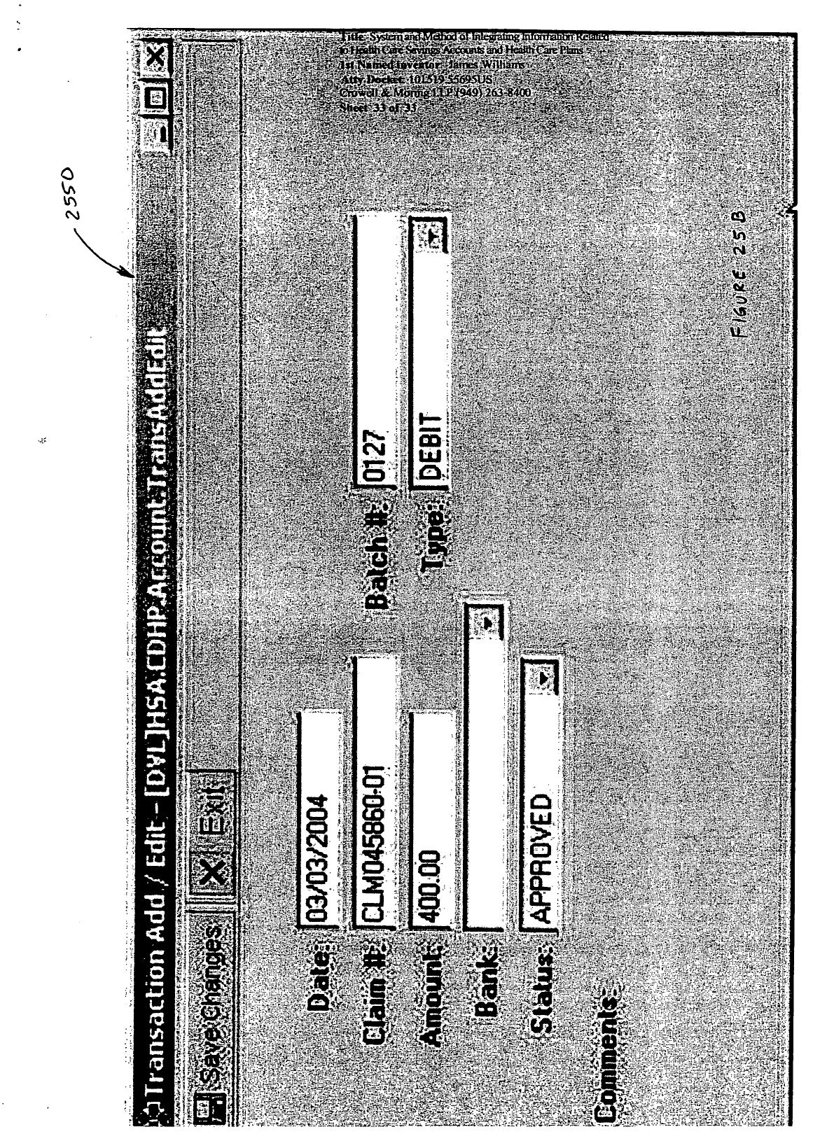

FIG. 25A illustrates a screen shot of an exemplary Transaction webpage 2500 generated by the HSA-MP integration server in accordance with another embodiment of the invention. The transaction webpage 2500 facilitates a subscriber in providing approval for payment of a claim from funds in the HSA account. The transaction webpage 2500 includes a section containing the subscriber's personal information and another section containing information about payment/adjustment requests. The payment/adjustment requests section includes information about claims and their payment status. In this example, this section is showing a claim for $400.00 and approved for payment.

FIG. 25B illustrates a screen shot of an exemplary Transaction sub-webpage 2550 generated by the HSA-MP integration server in accordance with another embodiment of the invention. In the Transaction webpage 2500, a subscriber may click on the claim entry to ascertain more detailed information about the claim. In this example, the subscriber clicked the only entry to ascertain more information about the claim. In response, the HSA-MP integration server provides the sub-webpage 2350 to the subscriber, which provides further details about the claim. In the case where the payment of the claim has yet to be approved, the subscriber may approve the payment of the status by changing the status of the payment in the status field of the input object provided in the Transaction sub-webpage 2550. This would instruct the HSA-MP integration server to commence the payment of the claim as previously discussed.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method comprising:
receiving information related to a health care savings account pertaining to a subscriber by way of an interface;
receiving information related to a health care plan pertaining to said subscriber by way of said interface; and
integrating said health care savings account information and said health care plan information into a subscriber data object.

2. The method of claim 1, wherein said health care savings account information comprises any one or more of the following information:
information related to an identification of said health care savings account
information related to an account balance of said health care savings account;
information related to contributions made to said health care savings account, and
information related to withdrawals made from said health care savings account.

3. The method of claim 2, wherein said information related to said contributions made to said health care savings account comprises any one or more of the following information:
information related to contributions made to said health care savings account by said subscriber;
information related to contributions made to said health care savings account by an employer of said subscriber;
information related to interest accrued in said health care savings account;
information related to an investment fund transferred back into said health care savings account; and
information related to funds rolled from another health care savings account.

4. The method of claim 2, wherein said information related to said withdrawals made from said health care savings account comprises any one or more of the following information:
information related to withdrawals made from said health care savings account using an integration software module;
information related to withdrawals made from said health care savings account using a credit card associated with said account;
information related to withdrawals made from said health care savings account using a debit card associated with said account; and
information related to funds transferred from said health care savings account to an investment account.

5. The method of claim 1, wherein said health care savings account comprises any of the following:
a Health Savings Account (HSA);
a Flexible Savings Accounts (FSA);
a Healthcare Reimbursement Account (HRA); and
a Medical Savings Account (MSA).

6. The method of claim 1, wherein said health care savings account information is received from a financial institution server.

7. The method of claim 1, wherein said health care plan information comprises any one or more of the following information:
information related to benefits offered by said health care plan; and
information related to a claim for a medical service performed on said subscriber and/or a medical product purchased by said subscriber.

8. The method of claim 7, wherein said information related to benefits offered by said health care plan comprises any one or more of the following information:
information related to a deductible;
information related to a co-payment; and
information related to a benefit maximum.

9. The method of claim 7, wherein said information related to said claim for said medical services performed on said subscriber and/or said medical product purchased by said subscriber comprises any one or more of the following information:
information related to a date of said claim;
information related to an identification of said claim;
information related to a provider that performed said medical services on said subscriber and/or sold said medical product to said subscriber;
information related to an amount billed for said claim;
information related an amount of payment made towards said claim;
information related to an amount of said payment counting towards a deductible;
information related to an amount of said payment qualifying as a full or partial tax exempt expense; and
information related to provider discount.

10. The method of claim 1, wherein said health care plan comprises any one or more of the following:
a primary health care plan of said subscriber;
a dental health care plan of said subscriber;
a long term health care plan of said subscriber; and
a vision health care plan of said subscriber.

11. The method of claim 1, wherein said health care plan information is received from any one or more of the following:
a health care insurer server; and
a third party administrator (TPA) server.

12. The method of claim 11, wherein said health care insurer server comprises any one or more of the following:
a primary health care insurer server;
a dental health care insurer server;
a long term health care insurer server; and
a vision care health care insurer server.

13. The method of claim 1, wherein said interface comprises any one or more of the following:
a network interface;
a software interface; and
a hardware interface.

14. The method of claim 1, further comprising:
receiving a request for said health care savings account information and/or said health plan information from a requesting entity by way of said interface;
accessing said requested health care savings account information and/or said health plan information from said subscriber data object; and
providing said requested health care savings account information and/or said health plan information to said requesting entity by way of said interface.

15. The method of claim 14, wherein providing said requested health care savings account information and/or said health plan information to said requesting entity, comprises:
forming a webpage containing said requested health care savings account information and/or said health plan information; and
sending said webpage to said requesting entity by way of said interface.

16. The method of claim 14, wherein said requesting entity comprises a subscriber unit.

17. The method of claim 14, wherein said requesting entity comprises a server operated by a third party.

18. The method of claim 17, wherein said third party includes an employer of said subscriber.

19. The method of claim 17, further comprising receiving an approval to send said requested health care savings account information and/or said health plan information to said third party from a subscriber unit by way of the interface.

20. The method of claim 14, wherein providing said requested health care savings account information and/or said health plan information to said requesting entity, comprising:
formatting said requested health care savings account information and/or said health plan information into a file recognized by a tax form preparation software module; and
sending said file to said requesting entity by way of said interface.

21. The method of claim of claim 1, further comprising:
sending an enrollment application to a subscriber unit by way of said interface;
receiving information requested by said enrollment application from said subscriber unit by way of said interface; and
modifying said subscriber data object to include said enrollment application information.

22. The method of claim 1, further comprising:
receiving a request for payment of a claim by way of said interface;
sending a request for payment of said claim to a subscriber unit by way of said interface;
receiving an approval for the payment of said claim from said subscriber unit by way of said interface; and
sending a transaction request for payment of said claim to a financial institution by way of said interface.

23. The method of claim 1, further comprising:
receiving information related to a non-health care financial account and/or line-of-credit from a subscriber unit by way of said interface;
receiving information related to a condition as to when to use funds from said non-health care financial account and/or line-of-credit; and
integrating said non-health care financial account and/or line-of-credit information and said condition information into said subscriber data object.

24. The method of claim 23, further comprising:
receiving a request for payment of a claim by way of said interface;
receiving an approval for the payment of said claim from a subscriber unit by way of said interface;
accessing said subscriber data object to determine from which of said health care savings account, non-health care financial account, and/or line-of-credit to withdrawal funds for payment of said claim based on said condition information; and
sending one or more transaction requests for payment of said claim to one or more financial institutions managing said health care savings account, non-health care financial account, and/or line-of-credit by way of said interface.

25. The method of claim 1, further comprising:
receiving information related to a claim by way of said interface;
receiving information related to a transaction made from funds from said health care savings account; and
correlating said claim information with said transaction information to match said claim with said transaction.

26. The method of claim 1, further comprising:
receiving information related to an investment account from a subscriber unit by way of said interface;
receiving a request to transfer funds in said health care savings account to said investment account from said subscriber unit by way of said interface; and
sending a fund transfer request to transfer funds from said health care savings account to said investment account to a financial institution by way of said interface.

27. The method of claim 1, further comprising:
receiving information related to an investment account from a subscriber unit by way of said interface;
receiving a request to transfer funds in said investment account to said health care savings account from said subscriber unit by way of said interface; and
sending a fund transfer request to transfer funds from said investment account to said health care savings account to a financial institution by way of said interface.

28. The method of claim 1, further comprising:
receiving information related to providers that provide medical services and/or medical products;
receiving a request for said providers information from a subscriber unit by way of said interface; and
sending said providers information to said subscriber unit by way of said interface.

29. The method of claim 28, further comprising:
receiving a request to make an appointment with a selected provider of medical services from said subscriber unit by way of said interface; and
sending an appointment request to said selected provider by way of said interface.

30. The method of claim 28, further comprising:
receiving a request to purchase a product from a selected provider from said subscriber unit by way of said interface;
sending an order for said product to said selected provider by way of said interface; and
sending a transaction request for the payment of said order to a financial institution by way of said interface.

31. The method of claim 1, further comprising:
forming a plurality of subscriber data objects pertaining to respective subscribers, wherein said subscriber data objects includes respective subscribers' information related to health care savings accounts and health plan information;
receiving a request to perform a statistical analysis on information in said plurality of subscriber data objects from a requesting entity by way of said interface;
performing said statistical analysis on information in said plurality of subscriber data objects;
generating a report containing a result of said statistical analysis; and
sending said report to said requesting entity by way of said interface.

32. The method of claim 1, further comprising deriving additional information from said health care savings account information and said health care plan information.

33. The method of claim 32, wherein said additional information comprises any one or more of the following information:
an amount of health care expenses that count towards a deductible;
an amount of additional expenses required to meet said deductible;
an amount of withdrawals from said HSA account that went towards qualified medical expenses; and
an amount of withdrawals from said HSA account that went towards unqualified expenses.

34. A system comprising:
an interface;
a memory; and
a processor adapted to:
receive information related to a health care savings account pertaining to a subscriber by way of said interface;
receive information related to a health care plan pertaining to said subscriber by way of said interface; and
integrate said health care savings account information and said health care plan information in a subscriber data object stored in said memory.

35. The system of claim 34, wherein said processor is further adapted to:
receive a request for said health care savings account information and/or said health plan information from a requesting entity by way of said interface;
access said requested health care savings account information and/or said health plan information from said subscriber data object; and
send said requested health care savings account information and/or said health plan information to said requesting entity by way of said interface.

36. The system of claim 35, wherein said processor is further adapted to receive an approval to send said requested health care savings account information and/or said health plan information to said requesting entity from said subscriber unit by way of the interface.

37. The system of claim 35, wherein said processor is further adapted to:
format said requested health care savings account information and/or said health plan information into a file recognized by a tax form preparation software module; and
send said file to said requesting entity by way of said interface.

38. The system of claim of claim 34, wherein said processor is further adapted to:
send an enrollment application to a subscriber unit by way of said interface;
receive information requested by said enrollment application from said subscriber unit by way of said interface; and
modify said subscriber data object to include said enrollment application information.

39. The system of claim 34, wherein said processor is further adapted to:
receive a request for payment of a particular claim by way of said interface;
send a request for approval to pay said particular claim to a subscriber unit by way of said interface;
receive said approval from said subscriber unit by way of said interface; and
send a transaction request for payment of said particular claim to a financial institution by way of said interface.

40. The system of claim 34, wherein said processor is further adapted to:
receive information related to a non-health care financial account and/or line-of-credit from a subscriber unit by way of said interface;
receive information related to a condition as to when to use funds from said non-health care financial account and/or line-of-credit from said subscriber unit by way of said interface; and
integrate said non-health care financial account and/or line-of-credit information and said condition information into said subscriber data object.

41. The system of claim 40, wherein said processor is further adapted to:
receive a request for payment of a particular claim by way of said interface;
receive an approval for the payment of said particular claim from a subscriber unit by way of said interface;
access said subscriber data object to determine from which of said health care savings account, non-health care financial account, and/or line-of-credit to withdrawal funds for payment of said particular claim based on said condition information; and
send one or more transaction requests for payment of said particular claim to one or more financial institutions managing said health care savings account, non-health care financial account, and/or line-of-credit by way of said interface.

42. The system of claim 34, wherein said processor is further adapted to:
receive information related to a particular claim by way of said interface;
receive information related to a particular transaction made from funds from said health care savings account; and
correlate said claim information with said transaction information to match said particular claim with said particular transaction.

43. The system of claim 34, wherein said processor is further adapted to:
receive information related to an investment account from a subscriber unit by way of said interface;
receive a request to transfer funds in said health care savings account to said investment account from said subscriber unit by way of said interface; and
send a fund transfer request to transfer funds from said health care savings account to said investment account to a financial institution by way of said interface.

44. The system of claim 34, wherein said processor is further adapted to:
receive information related to an investment account from a subscriber unit by way of said interface;
receive a request to transfer funds in said investment account to said health care savings account from said subscriber unit by way of said interface; and
send a fund transfer request to transfer funds from said investment account to said health care savings account to a financial institution by way of said interface.

45. The system of claim 34, wherein said processor is further adapted to:
receive information related to providers that provide medical services and/or medical products by way of said interface;
receive a request for said providers information from a subscriber unit by way of said interface; and
send said providers information to said subscriber unit by way of said interface.

46. The system of claim 45, wherein said processor is further adapted to:
receive a request to make an appointment with a selected provider of medical services from said subscriber unit by way of said interface; and
send an appointment request to said selected provider by way of said interface.

47. The system of claim 45, wherein said processor is further adapted to:
receive a request to purchase a product from a selected provider from said subscriber unit by way of said interface;
send an order for said product to said selected provider by way of said interface; and
send a transaction request for the payment of said order to a financial institution by way of said interface.

48. The system of claim 34, wherein said processor is further adapted to:
form a plurality of subscriber data objects pertaining to respective subscribers, wherein said subscriber data objects includes respective subscribers' information related to health care savings accounts and health plan information;
receive a request to perform a statistical analysis on information in said plurality of subscriber data objects from a requesting entity by way of said interface;
perform said statistical analysis on information in said plurality of subscriber data objects;
generate a report containing a result of said statistical analysis; and
send said report to said requesting entity by way of said interface.

49. The system of claim 34, wherein said processor is further adapted to derive additional information from said health care savings account information and said health care plan information.

50. The system of claim 49, wherein said additional information comprises any one or more of the following information:
an amount of health care expenses that count towards a deductible;
an amount of additional expenses required to meet said deductible;
an amount of withdrawals from said HSA account that went towards qualified medical expenses; and
an amount of withdrawals from said HSA account that went towards unqualified expenses.

51. The system of claim 34, wherein said processor resides in a local network operated by a financial institution.

52. The system of claim 34, wherein said processor resides in a local network operated by a health care insurer.

53. A computer readable medium comprising one or more software modules adapted to control a processor to:
receive information related to a health care savings account pertaining to a subscriber;
receive information related to a health care plan pertaining to said subscriber; and
integrate said health care savings account information and said health care plan information into a subscriber data object.

54. The computer readable medium of claim 53, wherein said one or more software modules are adapted to control a processor to:
receive a request for said health care savings account information and/or said health plan information from a requesting entity;
access said requested health care savings account information and/or said health plan information from said subscriber data object; and
send said requested health care savings account information and/or said health plan information to said requesting entity.

55. The computer readable medium of claim 54, wherein said one or more software modules are adapted to control a processor to receive an approval to send said requested health care savings account information and/or said health plan information to said requesting entity.

56. The computer readable medium of claim 54, wherein said one or more software modules are adapted to control a processor to:
format said requested health care savings account information and/or said health plan information into a file recognized by a tax form preparation software module; and
send said file to said requesting entity by way of said interface.

57. The computer readable medium of claim of claim 53, wherein said one or more software modules are adapted to control a processor to:
send an enrollment application to a subscriber unit;
receive information requested by said enrollment application from said subscriber unit; and
modify said subscriber data object to include said enrollment application information.

58. The computer readable medium of claim 53, wherein said one or more software modules are adapted to control a processor to:
receive a request for payment of a particular claim;
send a request for approval to pay of said particular claim to a subscriber unit;
receive said approval from said subscriber unit; and
send a transaction request for payment of said particular claim to a financial institution.

59. The computer readable medium of claim 53, wherein said one or more software modules are adapted to control a processor to:
receive information related to a non-health care financial account and/or line-of-credit from a subscriber unit;
receive information related to a condition as to when to use funds from said non-health care financial account and/or line-of-credit from said subscriber; and
integrate said non-health care financial account and/or line-of-credit information and said condition information into said subscriber data object.

60. The computer readable medium of claim 59, wherein said one or more software modules are adapted to control a processor to:
receive a request for payment of a particular claim;
receive an approval for the payment of said particular claim from a subscriber unit;
access said subscriber data object to determine from which of said health care savings account, non-health care financial account, and/or line-of-credit to withdrawal funds for payment of said particular claim based on said condition information; and
send one or more transaction requests for payment of said particular claim to one or more financial institutions managing said health care savings account, non-health care financial account, and/or line-of-credit.

61. The computer readable medium of claim 53, wherein said one or more software modules are adapted to control a processor to:
receive information related to a particular claim;
receive information related to a particular transaction made from funds from said health care savings account; and
correlate said claim information with said transaction information to match said particular claim with said particular transaction.

62. The computer readable medium of claim 53, wherein said one or more software modules are adapted to control a processor to:
receive information related to an investment account from a subscriber unit;
receive a request to transfer funds in said health care savings account to said investment account from said subscriber unit; and
send a fund transfer request to transfer funds from said health care savings account to said investment account to a financial institution.

63. The computer readable medium of claim 53, wherein said one or more software modules are adapted to control a processor to:
receive information related to an investment account from a subscriber unit;
receive a request to transfer funds in said investment account to said health care savings account from said subscriber unit; and
send a fund transfer request to transfer funds from said investment account to said health care savings account to a financial institution.

64. The computer readable medium of claim 53, wherein said one or more software modules are adapted to control a processor to:
receive information related to providers that provide medical services and/or medical products;
receive a request for said providers information from a subscriber unit; and
send said providers information to said subscriber unit.

65. The computer readable medium of claim 64, wherein said one or more software modules are adapted to control a processor to:
receive a request to make an appointment with a selected provider of medical services from said subscriber unit; and
send an appointment request to said selected provider.

66. The computer readable medium of claim 64, wherein said one or more software modules are adapted to control a processor to:
receive a request to purchase a product from a selected provider from said subscriber unit;
send an order for said product to said selected provider; and
send a transaction request for the payment of said order to a financial institution.

67. The computer readable medium of claim 53, wherein said one or more software modules are adapted to control a processor to:
form a plurality of subscriber data objects pertaining to respective subscribers, wherein said subscriber data objects include respective subscribers' information related to health care savings accounts and health plan information;
receive a request to perform a statistical analysis on information in said plurality of subscriber data objects from a requesting entity;
perform said statistical analysis on information in said plurality of subscriber data objects;
generate a report containing a result of said statistical analysis; and
send said report to said requesting entity.

68. The computer readable medium of claim 53, wherein said one or more software modules are adapted to control a processor to derive additional information from said health care savings account information and said health care plan information.

69. The computer readable medium of claim 68, wherein said additional information comprises any one or more of the following information:
an amount of health care expenses that count towards a deductible;
an amount of additional expenses required to meet said deductible;
an amount of withdrawals from said HSA account that went towards qualified medical expenses; and
an amount of withdrawals from said HSA account that went towards unqualified expenses.
